(19) United States
(12) Patent Application Publication
(10) Pub. No.: US 2002/0152261 A1
(43) Pub. Date: Oct. 17, 2002

(54) Method and system for preventing the infringement of intellectual property rights

(76) Inventors: Jed Arkin, Silver Spring, MD (US); Daniel Weiser, Brooklyn, NY (US); Kurt Inderbitzin, Los Angeles, CA (US)

Correspondence Address: TESTA, HURWITZ & THIBEAULT, LLP, HIGH STREET TOWER, 125 HIGH STREET, BOSTON, MA, 02110, US

(21) Appl. No.: 09/836,879

(22) Filed: Apr. 17, 2001

(51) Int. Cl. G06F 15/16

(52) U.S. Cl. 709/202; 709/225; 709/229

(57) ABSTRACT

System for preventing the infringement of intellectual property rights including a searching server for identifying an infringing item in a network, a production server for producing modified copies of IP protected items and a sharing structure for sharing the modified copies over the network. The sharing structure includes a plurality of repositories and a plurality of sharing users. The repositories are mainly storage units storing many copies of the modified copies. The sharing users share the modified copies over the network either by uploading the modified copies from the repositories there through to a downloading node across the network, or by directing the downloading node to download directly from the repositories.

### FIELD OF THE INVENTION

The present invention relates to networks in general, and to methods and systems for preventing intellectual property rights infringement of computer objects, in particular.

### BACKGROUND OF THE INVENTION

The use of Internet by the general public, and with it the World Wide Web, is growing at an exponential rate. According to an NUA survey, as of July 2000, there were 333 million users world wide. A large percentage of these users regularly post on the Internet, electronic objects or a part thereof, such as software, surveys, pictures, music, films, animations, novels, poems and research reports. Some of these items are intellectual property and are protected by intellectual property legislation, such as copyright, Trademarks, patents, and the like.

Methods and systems which try to circumvent the problem of copyright infringement, are known in the art. Some of these methods employ encryption as a means to prevent the use of copyright material by unauthorized persons. Others employ public-private keys, passwords or embedded electronic signatures. A musical band, called Bare Naked Ladies distributed files bearing the names of their own music tracks in the Napster network, and attached a warning statement to each of these files, which notified the user that she is infringing Intellectual Property (IP) protected rights.

U.S. Pat. No. 6,119,108 entitled “Secure Electronic Publishing System” issued to Holmes et al., is directed to a method for charging a user for the use of an electronic object through the Internet. When the user attempts to open the object, access to the object is interrupted and she is connected with the purchasing authority system, to conduct a financial transaction therewith. If the user is interested in opening the electronic object, she supplies her personal information such as name, address, and telephone number, as well as payment information such as credit card information. Then the user is given a password to access the object. Other users can likewise gain access to the object by obtaining a personal password from the purchasing authority system. Hence, only those users who have arranged payment, can access a specific object on the Internet.

U.S. Pat. No. 5,987,126 issued to Okuyama et al., and entitled “Device Having a Digital Interface and a Network System Using Such a Device and a Copy Protection Method”, is directed to a method for controlling the recording of sound or video, according to copy generation management information. A first and a second sending (reproduction) device are connected to a receiving (recording) device, via an IEEE 1394 standard bus.

The first sending device includes a reproduction processing circuit, a D-interface format output processing circuit, an IEEE 1394 interface and a copy flag detecting circuit. The D-interface format output processing circuit, the IEEE 1394 interface and the copy flag detecting circuit are interconnected. The reproduction processing circuit is connected to a reproduction device and to the D-interface format output processing circuit. The second sending device includes a decoding circuit, an MPEG output processing circuit, an IEEE 1394 interface and a copy flag detecting circuit. The MPEG output processing circuit, the IEEE 1394 interface and the copy flag detecting circuit are interconnected. The decoding circuit is connected to a reproduction device and to the MPEG output processing circuit.

The receiving device includes a IEEE 1394 interface, a format converting circuit, a recording processing circuit, a copy generation circuit and a recording controlling circuit. The IEEE 1394 interface includes a copy flag detector. The copy flag detector is connected to the copy generation circuit and to the recording controlling circuit. The recording processing circuit is connected to the recording controlling circuit and to the format converting circuit. The format converting circuit is connected to the copy generation circuit and to the IEEE 1394 interface. The IEEE 1394 interfaces of the first and the second sending devices are connected to the IEEE 1394 interface of the receiving device via the IEEE 1394 bus.

The copy flag detecting circuit of the first and the second device detects the copy generation management information embedded in the source control packet, and sends this information to copy flag detector of the receiving device via the IEEE 1394 interface. For example, if the copy generation management information detected by the copy flag detector is “11”, which prohibits copying, then the recording processing circuit of the receiving device controls the operation of the servo circuit, so as to omit recording.

U.S. Pat. No. 5,867,579 issued to Saito and entitled “Apparatus For Data Copyright Management System”, is directed to a system to manage data which are protected by copyright. The system includes a key control center connected to a read only memory (ROM), a read and write memory (RAM) and to an electrically erasable programmable read only memory (EEPROM) via a local bus. The system bus of a user terminal is connected to the local bus of the system. The user terminal includes an MPU connected to a communication unit (COMM), a CD-ROM drive (CDRD), a flexible disk drive (FDD) and to a hard disk drive (HDD), via the system bus.

Fixed information such as data copyright management program, a cryptography program, user data, a decryption program, a re-encryption program and a program for generating secret keys are stored in the ROM. A crypt key and the copyright information are stored in the EEPROM. Either one of the first crypt-key or the second crypt-key and data copyright management system program are stored in the RAM of the system and in the RAM of the user terminal.

A primary user receives the first secret-key as a decryption key and the second secret-key as an encryption/decryption key. The encrypted original data is decrypted using the first secret-key. When the data is stored in a memory or in a hard disk drive, only the primary user can use the data. When the original data or the edited data is stored in the memory of the primary user terminal, only the primary user can use the data. When the original data is copied and supplied to a secondary user, the copyright of the primary user is not affected on the original data.

When the primary user produces an edited data by editing the original data or combining the original data with other data, the secondary exploitation right of the primary user (i.e., the copyright of the primary user) is affected. The primary user, then requests a second-key from the key control center. Thereafter, the primary user decrypts and encrypts the data, using the secondary secret-key. Similarly, when the secondary user produces an edited data from the original data, or edits the data obtained from the primary user, the copyright of the secondary user is affected. The secondary user can use the data, by designating the original data name or data number, the secondary user information and the unencrypted primary user information to the copyright management center. The copyright management center confirms that the primary user has received the second secret-key, and then transfers the second secret-key to the secondary user.

U.S. Pat. No. 5,790,236 issued to Hershtik et al., and entitled “Movie Processing System”, is directed to a method and a system for modifying the soundtrack or the picture frames of a video, by producing respective sound and frame characteristics. Initially, different versions of a movie are entered to the system. The resolution of each version is reduced, for each version a plurality of sound characteristics and frame characteristics are produced and these characteristics are stored in a memory. A movie version synchronizer analyzes the frame characteristics and produces indications of all the movie versions for which different movie segments appear.

An output movie editing list generator produces an editing list such as “intersection”, “union” or “complement to reference”, according to the output of the movie version synchronizer. An icon incorporation unit can use the “complement to reference” list to incorporate an icon with the frames, to indicate the language version of the movie. A reduced resolution video editing workstation employs the “intersection” editing list of the output movie editing list, to provide a high resolution video editing workstation, with the same movie segments which appear in different languages. The high resolution video editing workstation produces an output movie which includes a single video track and a plurality of soundtracks in different languages.

U.S. Pat. No. 5,892,825 issued to Mages et al., and entitled “Method of Secure Server Control of Local Media Via a Trigger Through a Network for Instant Local Access of Encrypted Data on Local Media”, is directed to a method to enable reading of a CD-ROM whose reading had been previously disabled. A user is originally supplied with a crippled CDROM whose audio/video header is removed, thus preventing the computer of the user to read these audio/video data. The crippled CD-ROM includes the uniform resource locator (URL) of the web site which can provide the user with a de-crippling key. The user initiates a socket-to-socket connection between her computer and the server of the web site, and the de-crippling key is transmitted to the computer and stored in the RAM thereof. In RAM, the de-crippling key and the data of the CD-ROM are combined, thereby enabling the playback of the audio/video data.

U.S. Pat. No. 5,787,068 issued to Arps et al., and entitled “Method and Arrangement for Preventing Unauthorized Duplication of Optical Discs Using Barriers”, is directed to a method for preventing unauthorized copying of data recorded on optical discs, such as CD-ROM. In a conventional CD-ROM, data is recorded contiguously in a spiral track. According to this patent, gaps and barriers or decoy files are placed between real data files and a directory is recorded at the beginning of the spiral track, which includes pointers to each of the real files. An optical reading head which attempts to read the data, derails from the track when it discovers these gaps and barriers, and thus unauthorized reading of data is prevented. Authorized reading is facilitated by the pointers of the directory which instruct the reading head to read the data files non-contiguously.

U.S. Pat. No. 5,923,763 issued to Walker et al., and entitled “Method and Apparatus for Secure Document Timestamping”, is directed to a method and a system to prevent forging of documents, by generating a timestamp for the document. The system includes a cryptographic processor, a random number generator, a clock, a signal receiver, an internal power source, a RAM memory and a non-volatile memory interconnected via a bus. The system is connected to an input device, such as a push button, an output device, such as a printer and to an external power source, via the bus. The clock is either internal or external, such as the timing signal of a global positioning system (GPS) and the US Observatory atomic clock.

The system creates a timestamp according to a request from the input device and outputs the timestamp to the output device. The cryptographic processor generates a timestamp from the clock and outputs the timestamp consisting of the cleartext time, plus a one way function which represents the time. The one way function can be a hash, a message authenticity code (MAC) and a cyclic redundancy check (CRC). The one way function allows one to determine if the document has been tampered. The hashing algorithm can be stored either in the RAM or in the non-volatile memory.

The user produces a chained hash for the document, whose timestamp includes for example, three consecutive dates. If a forger discovers the private key of the user and alters the timestamp of one of these dates, then the user can recompute the subsequent three timestamps and compare them with their known values. If the known and the computed timestamp disagree, then the user can determine that the timestamp of one of these dates has been altered. The forger can change all the timestamps in the chained hash, but this requires more effort than changing the desired one, and also increases the chances of detection. The random number generator generates random numbers to prevent generation of reused timestamps.

U.S. Pat. No. 6,047,242 issued to Benson, and entitled “Computer System for Protecting Software and a Method for Protecting Software”, is directed to a method for purchasing software which is protected by electronic copy and license protection (ECP). The customer downloads a protected software from the vendor, the customer sends a registration package to the vendor, and the vendor generates a keyfile for the customer and sends the keyfile to the customer.

A challenge mechanism is embedded in the protected software, such that an attacker can not easily separate the challenge mechanism from the protected software. The public keying material of the vendor is embedded in the challenge mechanism. The vendor signs both the protected software and the challenge mechanism, using her private key. The registration package includes a reference to a public directory which holds the public keying material of the customer.

The keyfile includes the public keying material of the customer along with thousands of decoy bits. The customer information is embedded in the keyfile, in encrypted form, while the encryption key is not disclosed. The vendor can identify the owner of the keyfile, when the keyfile appears in a public location, such as a bulletin board. The vendor signs the keyfile, by employing a keyfile generator, the private keying material of the vendor and by applying a digital signature algorithm. When the customer installs the keyfile, the challenge mechanism allows the customer to execute the protected software, if the customer can prove that she has access to the private keying material of the customer.

### SUMMARY OF THE PRESENT INVENTION

It is an object of the present invention to provide a novel method and system for preventing the infringement of intellectual property rights, which overcomes the disadvantages of the prior art. In accordance with one aspect of the present invention, there is thus provided a searching server for identifying an infringing item in a network. The searching server includes a sniffing user and a characteristics database. The sniffing user is connected to the network and the characteristics database is connected to the sniffing user.

The characteristics database includes Intellectual Property (IP) item characteristics of IP items. The sniffing user detects an infringing item using a directory available on the network. The sniffing user retrieves infringing item characteristics from the network. The searching server identifies the infringing item, by comparing the infringing item characteristics with the IP item characteristics.

In accordance with another aspect of the present invention, there is thus provided a system for producing IP item modified copies. The system includes a network interface and a processor. The network interface is connected to a network and to the processor. The processor produces modified copies from IP items and the modified copies are made available to the network via the network interface.

In accordance with a further aspect of the present invention, there is thus provided a modified item. The modified item includes modified item characteristics and modified item content. The modified item is produced according to at least one item characteristics, item content and supplementary material.

In accordance with another aspect of the present invention, there is thus provided a system for sharing items in a network. The system includes at least one storage unit for storing modified copies of a plurality of items and at least one network interface connected to one of the storage units and to the network. Each network interface is associated with a different selection of modified copies. Each network interface shares the modified copies associated therewith, over the network.

In accordance with a further aspect of the present invention, there is thus provided a method for reducing the probability for identifying an item in a network. The method includes the steps of associating a plurality of network interfaces with modified copies of items and enabling the availability of the modified copies through the network interfaces.

In accordance with another aspect of the present invention, there is thus provided a method for detecting an infringing copy of an IP item in a network. The method includes the steps of inspecting a search result for identifying the infringing copy and comparing at least one infringing copy characteristic of the infringing copy, with at least one IP item characteristic of the IP item, when the infringing copy is identified.

### BRIEF DESCRIPTION OF THE DRAWINGS

The present invention will be understood and appreciated more fully from the following detailed description taken in conjunction with the drawings in which:

FIG. 1 is a schematic illustration of an item sharing server, constructed and operative in accordance with a preferred embodiment of the present invention;

FIG. 2 is a schematic illustration of a production server, constructed and operative in accordance with another preferred embodiment of the present invention;

FIG. 3 is a schematic illustration of a computer system, constructed and operative in accordance with a further preferred embodiment of the present invention;

FIG. 4A is a schematic illustration of an item sharing server, constructed and operative in accordance with another preferred embodiment of the present invention;

FIG. 4B is a schematic illustration of an item sharing server, constructed and operative in accordance with a further preferred embodiment of the present invention;

FIG. 5 is a schematic illustration of an item sharing server, constructed and operative in accordance with another preferred embodiment of the present invention;

FIG. 6 is a schematic illustration of a method for proliferating unusable copies of an item in a network, operative in accordance with a further preferred embodiment of the present invention;

FIG. 7 is a schematic illustration of step 400 of FIG. 6, operative in accordance with another preferred embodiment of the present invention;

FIG. 8 is a schematic illustration of a computer system, constructed operative in accordance with a further preferred embodiment of the present invention;

FIG. 9 is a schematic illustration of a computer system, constructed operative in accordance with another preferred embodiment of the present invention; and

FIG. 10 is a schematic illustration of a computer system, constructed operative in accordance with a further preferred embodiment of the present invention.

### DETAILED DESCRIPTION OF PREFERRED EMBODIMENTS

The present invention overcomes the disadvantages of the prior art by providing a system and a method which reduce the probability of accessing an intellectual property (IP) infringing object, on an information network, by distributing a large number of modified mockup copies of that IP infringing object, bearing the same characteristics. Accordingly, a user searching for the IP infringing object would receive a search list which includes a large number of the modified mockup copies and may also include the IP infringing object, from which the user selects an object to download. Provided that the modified mockup copies outnumber the copies of the IP infringing object, available on the network, then the probability of downloading the IP infringing object and not one of the modified mockup copies shall be significantly low. This low probability may discourage the user from downloading after a few unsuccessful attempts.

The term “IP protected item” herein below, refers to an item protected by copyright or other intellectual property rights, for which a user owns a valid license on behalf of the owner of the item, to use the item. The term “infringing item” herein below, refers to an item or an object, which incorporates intellectual property rights, that may be infringed by the user which makes that item available on the network.

The term “supplementary material” herein below, refers to a portion of a media object or a collection of such portions, which is included in a modified item. The supplementary material can be an advertisement, a commercial promotion, a movie trailer, a link to legitimate sites, a warning statement which states that the downloaded object incorporates proprietary intellectual property rights, and the like, or a combination thereof. The warning statement can be in the form of text, graphics, video, animation, sound, and the like, or a combination thereof.

The term “usable” herein below, refers to an item whose content can be properly and entirely comprehended by a person to her satisfaction, when she opens the item on her user terminal and interacts therewith, using at least one of the five senses. The term “unusable” herein below, refers to an item whose content can not be properly and entirely comprehended or utilized by the person to her full satisfaction, when she attempts to interact therewith. An item can be rendered unusable, for example if it is a video, by changing the original sequence of the scenes. Thus, although the content of the unusable copy is identical with the content of the usable one, the person will not comprehend the theme of the video, even after viewing the entire unusable copy.

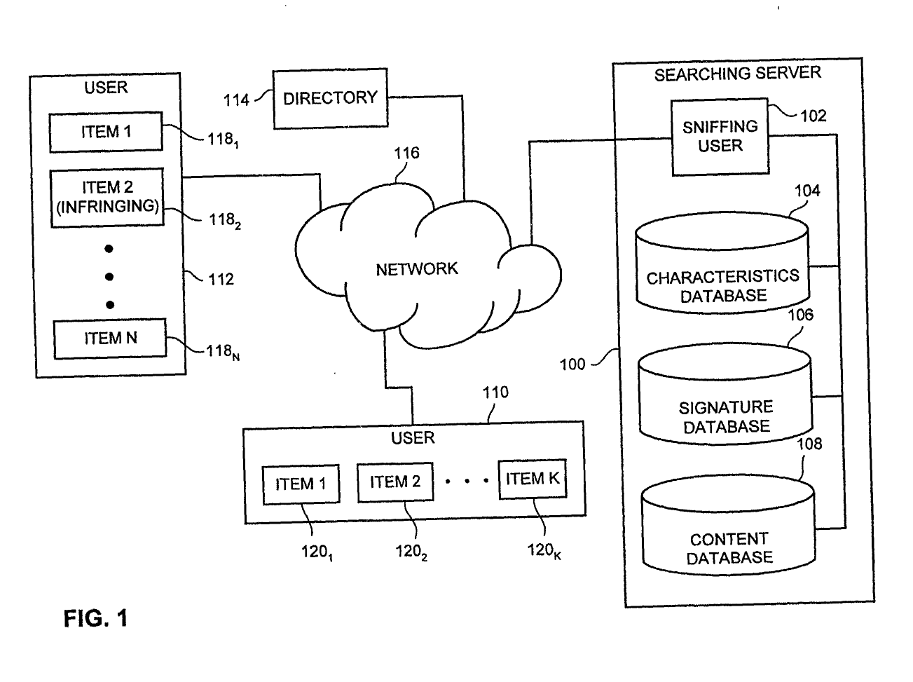

Reference is now made to FIG. 1, which is a schematic illustration of an item sharing server, generally referenced 100, constructed and operative in accordance with a preferred embodiment of the present invention. Searching server 100 includes a sniffing user 102, a characteristics database 104, a signature database 106 and a content database 108. Sniffing user 102 is connected to a network 116, characteristics database 104 and to signature database 106. Characteristics database 104 and signature database 106 are connected to content database 108.

Searching server 100, a user 110, a share-infringing user 112 and a directory 114 are connected to network 116, by a wired or wireless link, or a combination thereof. Network 116 is a publicly accessed network (e.g., the Internet) or network application (e.g., Napster, Gnutella, Scour, Freenet, imesh, and the like). Directory 114 is either a central directory or a distributed directory, spreading over a plurality of nodes in network 116. User 110 and share-infringing user 112 are workstations, desktops, laptops, mobile units, network user applications, and the like.

Users which are connected to network 116, can download items from one another. Each of these users can download an item from another user either directly (peer to peer), or indirectly through a mediator (e.g., through directory 114). For example, user 110 can download an infringing ITEM-2 118₂ from share-infringing user 112, thereby infringing intellectual property rights. Share-infringing user 112 can infringe IP rights by sharing infringing ITEM-2 118₂ with other users (not shown) and also by downloading other infringing items (not shown) from these other users.

A digital item is a digital entry, file, or object which can be processed by user 110, share-infringing user 112 and searching server 100 and downloaded from one user to another, either directly, or via a mediating node. A digital item can be in a format known in the art, such as MIDI, WAV, AVI, MPEG, JPEG, ASCII, TIFF, GIF, PDF, RTF, bitmap, and the like, or a combination thereof.

Share-infringing user 112 includes a plurality of items: ITEM-1 118₁, ITEM-2 118₂ and ITEM-N 118_{N}. ITEM-2 118₂ is an infringing copy of ITEM-2 120₂. User 110 includes a plurality of IP protected items: ITEM-1 120₁, ITEM-2 120₂ and ITEM-K 120_{K}. The content of infringing ITEM-2 118₂ and IP protected ITEM-2 120₂ is substantially identical, while their format may be different. Thus, share-infringing user 112 can download IP protected ITEM-2 120₂ from user 110 and store it in share-infringing user 112 as infringing ITEM-2 118₂, without obtaining a license to use IP protected ITEM-2 120₂.

When user 110 and share-infringing user 112 are both connected to network 116, share-infringing user 112 requests directory 114 to search for ITEM-1 120₁, while a downloading application runs in both user 110 and share-infringing user 112. Directory 114 provides share-infringing user 112 with search results. The search results indicate that ITEM-1 120₁ resides in user 110. Share-infringing user 112, then downloads ITEM-1 120₁ from user 110.

Content database 108 includes the content (e.g., audio, video, software, computer games, data, e-books, and the like) of a plurality of IP protected items (e.g., copyright protected items). Signature database 106 includes the signature of each of the IP protected items residing in content database 108.

A signature is uniquely derived from the item, its content or characteristics. An example for such a signature is hereby described in conjunction with digital video in MPEG format. The signature is produced as a sequence of numbers, from the I-Frames (i.e., intra-frame). Each of the numbers in the sequence is calculated according to a given function on predetermined areas in a selected I-Frame. In case of analog video in other formats, such as PAL, SECAM, NTSC, and the like, the signature is produced from a plurality of frames, which indicate a significant change in the visible content, such as a new video shot. Thus, a signature indicates the content of an item, while occupying a volume substantially smaller than the item itself. Similar signatures can be produced for audio and other media types. Characteristics database 104 includes the characteristics of each of the IP protected items stored in content database 108. The characteristics are the metadata of an item, such as title, file size, category, date of production, producer, performer, and the like.

Searching server 100 is a repository of a plurality of items, whose contents are stored in content database 108. Searching server 100 is either the owner of these items, or is authorized by the owner of these items, to take certain actions concerning these items. These actions can include modifying the item, uploading the modified item to a third party, making a plurality of the modified item available to the public, and the like. The address of each of the users who owns an IP protected item can be stored in searching server 100 (e.g., incorporated with characteristics database 104). Thus for example, searching server 100 can include the information that user 110 is the owner of IP protected ITEM-1 120₁ and ITEM-2 120₂, and that any copy of these items retrieved from address of user 110 are legitimate copies. Accordingly, server 100 can refrain from taking measures regarding the presence of ITEM-1 120₁ and ITEM-2 120₂ and their availability via user 110, provided that user 110 has the right to share the items.

Sniffing user 102 retrieves selected characteristics of an IP protected item, from characteristics database 104. Sniffing user 102 retrieves for example, the following characteristics from characteristics database 104, for ITEM-2: “Donald Duck in Jail” for the title, “Walt Disney Productions” for the producer and “Video” for the type of the item.

Sniffing user 102 then searches for an infringing copy of ITEM-2 in network 116, by producing a query according to the selected characteristics of ITEM-2 and providing that query to directory 114. This process can be fully automated. Directory 114 provides search results respective of the query. The search results indicate that ITEM-2 118₂ and ITEM-2 120₂, whose characteristics are similar to the selected characteristics, reside in user 110 and share-infringing user 112, respectively. Sniffing user 102 determines that ITEM-2 118₂ is an infringing copy of ITEM-2.

For increasing the certainty that ITEM-2 118₂ is indeed infringing, sniffing user 102 performs a verification procedure. Sniffing user 102 downloads at least a portion of infringing ITEM-2 118₂ to a storage unit (not shown) located in searching server 100 and compares the content of the downloaded item with a reference item, which is suspected of being infringed.

For this purpose, searching server 100 produces a signature for the downloaded infringing ITEM-2 118₂. It is noted that the signatures of items bearing identical content, but being in different formats, is essentially identical. For example, searching server 100 produces the same signature for a copy of “Donald Duck in Jail” video in MPEG version, PAL version and NTSC version. Searching server 100 produces a signature for the downloaded infringing ITEM-2 118₂ and retrieves the signature of ITEM-2 from signature database 106. Searching server 100 compares the produced signature of infringing ITEM-2 118₂ with the retrieved signature of ITEM-2. If all or a part of the two signatures are identical, then searching server 100 saves the characteristics of infringing ITEM-2 118₂.

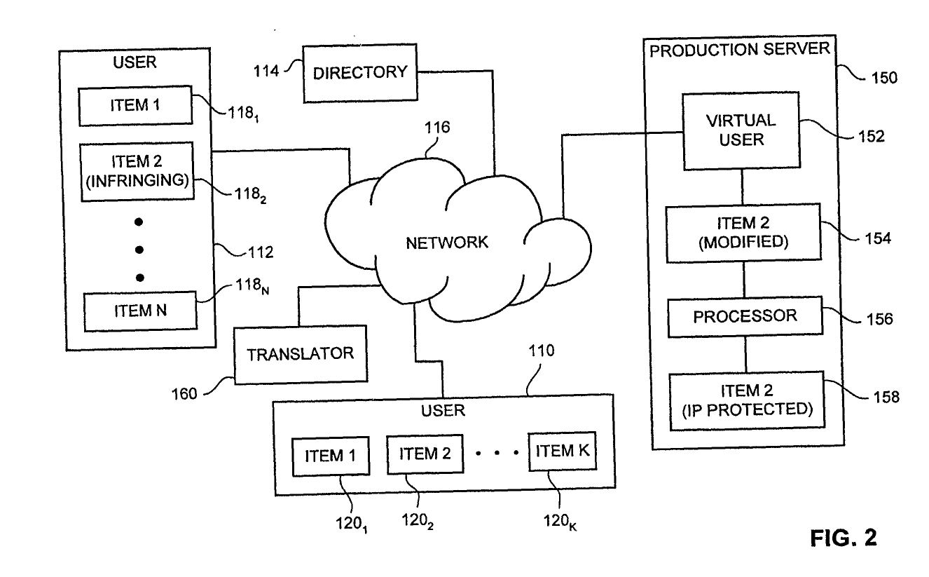

Reference is now made to FIG. 2, which is a schematic illustration of a production server, generally referenced 150, constructed and operative in accordance with another preferred embodiment of the present invention. Production server 150 includes a virtual user 152, a modified ITEM-2 154, a processor 156 and an IP protected ITEM-2 158. Virtual user 152 is connected to network 116 and to modified ITEM-2 154. User 110, share-infringing user 112, directory 114, a translator 160 and production server 150 are connected to network 116. Alternatively, virtual user 152 can be a network interface, a sharing user, and the like.

Translator 160 is an application, such as a web site, plug-in, and the like. Alternatively, translator 160 resides in user 110, share-infringing user 112 and in production server 150. Translator 160 produces a unique name for an item, according to the characteristics of the item, by employing a random key.

Processor 156 produces modified ITEM-2 154 by processing IP protected ITEM-2 158. Alternatively, processor 156 produces modified ITEM-2 154 by processing infringing ITEM-2 118₂. Modified ITEM-2 154 is an unusable copy of IP protected ITEM-2 158 (or infringing ITEM-2 118₂) having substantially the same characteristics (e.g., file name, file size, file type) as those of IP infringing ITEM-2 118₂. Thus, when user 110 searches network 116 for a copy of ITEM-2, it obtains search results which include infringing ITEM-2 118₂ and modified ITEM-2 154.

Directory 114 provides user 110 with information respective of the characteristics of infringing ITEM-2 118₂ and modified ITEM-2 154, such as title, file size, producer, and the like. However, because the characteristics of both infringing ITEM-2 118₂ and modified ITEM-2 154 are substantially the same, user 110 can not differentiate between the two, according to the information which it receives from directory 114.

Modified ITEM-2 154 can include out-of-sequence segments of IP protected ITEM-2 158 (or infringing ITEM-2 118₂), separated by one or more items of supplementary material. Alternatively, modified ITEM-2 154 can include out-of-sequence segments of IP protected ITEM-2 158, followed by one or more items of supplementary material. Further alternatively, the first portion of modified ITEM-2 154 can be a substantially small portion of the beginning of IP protected ITEM-2 158 and the rest of modified ITEM-2 154 can include recurring items of supplementary material. For example, if modified ITEM-2 154 is a video, it includes the first ten minutes of the original (IP protected) video, while the remainder includes recurring items of supplementary material. Thus, the modified copy is practically unusable. In all cases the size of modified ITEM-2 154 is substantially equal to the size of IP infringing ITEM-2 118₂.

It is noted that because the file size and other characteristics of the modified item are substantially identical with those of the IP protected item, a share-infringing user can not differentiate between the two items before and during the downloading of the modified item. The share-infringing user spends valuable resources to use an item which she later finds substantially unusable. Therefore, the share-infringing user is encouraged to arrange payment to the owner of the item, for downloading a legitimate copy of the item, or purchase a hard copy thereof.

According to another aspect of the present invention, production server 150 requests translator 160 to assign a translated name for modified ITEM-2 154. For example, if modified ITEM-2 154 is the “Donald Duck in Jail” cartoon, which was produced by Walt Disney Productions in 1966, then translator 160 assigns the name “ABC” for modified ITEM-2 154, according to the name of the cartoon, the producer and the year of production. Production server 150, then replaces the characteristics of modified ITEM-2 154 with the name “ABC”.

User 110, before searching for the “Donald Duck in Jail” cartoon, which was produced by Walt Disney Productions in 1966, provides translator 160 the characteristics of the cartoon and requests from translator 160, a translated name for this cartoon. Since the characteristics defined by production server 150 and user 110 for the cartoon are identical, translator 160 supplies the same name “ABC” for this cartoon, to user 110. User 110 searches network 116 for the item “ABC” and directory 114 notifies user 110 that item “ABC” (i.e., modified ITEM-2 154) resides in production server 150.

Infringing ITEM-2 118₂ is an infringing copy of the “Donald Duck in Jail” cartoon, which was produced by Walt Disney Productions in 1966. Share-infringing user 112 can request translator 160 to assign a translated name for infringing ITEM-2 118₂, by providing translator 160 the characteristics of the cartoon. Translator 160 supplies the name “ABC” for this cartoon, to share-infringing user 112. Share-infringing user 112, then replaces the characteristics of infringing ITEM-2 118₂ with the name “ABC”. In this case, when user 110 searches for the item “ABC” in network 116, directory 114 notifies user 110 that one copy of item “ABC” (i.e., modified ITEM-2 154) resides in production server 150, and another copy (i.e., infringing ITEM-2 118₂) resides in share-infringing user 112.

It is noted that production server 150 can initiate the production of mock-up copies as preemptive measures when a title is to be introduced to the public by the rightful owner, without searching for infringing copies. Furthermore, production server 150 can select a set of characteristics for the title, substantially identical with the characteristics which a share-infringing user generally selects for this type of title. For example, if a share-infringing user generally converts a legitimate WAV title of 50 Mbytes, to WAV format and in an MP3 compressed form of 3 Mbytes, then production server 150 produces the mock-up copy in MP3 format in a compressed form of 3 Mbytes.

According to another aspect of the present invention, production server 150 can produce different sets of mock-up copies of the title, while initiating the preemptive action. The characteristics of mock-up copies in one set is different from the characteristics of mock-up copies in another set. For example, each of the mock-up copies of the video “Donald Duck in Jail” in one set has the title “Donald Duck” and is compressed to 600 Mbytes, while each of the mock-up copies of the same video in another set has the title “Donald Duck in Prison” and is compressed to 100 Mbytes.

Share-infringing user 112 can attach a digital signature thereof, to infringing item 118₂ by employing a private key respective of that signature. Accordingly, any network user downloading infringing item 118₂, shall be able to authenticate infringing item 118₂ as an item provided or produced by share-infringing user 112, using the public key associated with that signature.

According to another aspect of the present invention, processor 156 obtains the signature characteristics of the signature of share-infringing user 112 (i.e., by deciphering it from a downloaded item, by downloading it from the network, and the like) and attaches that signature to modified ITEM-2 154. Hence, any user, which downloads modified ITEM-2 154 shall identify it as an authentic item of share-infringing user 112.

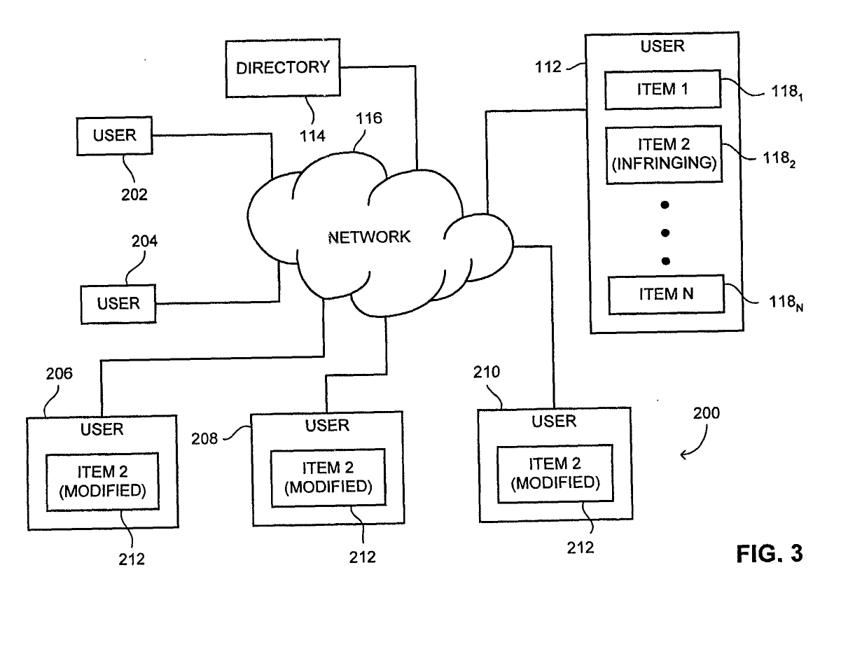

Reference is now made to FIG. 3, which is a schematic illustration of a computer system, generally referenced 200, constructed and operative in accordance with a further preferred embodiment of the present invention. System 200 includes distributed host users 206, 208 and 210 connected to network 116. Download-infringing users 202, 204, share-infringing user 112 and directory 114 are connected to network 116. Each of distributed host users 206, 208 and 210 includes a modified ITEM-2 212.

Modified ITEM-2 212 is similar to modified ITEM-2 154 (FIG. 2). ITEM-2 (not shown) is protected by intellectual property rights (e.g., copyright). Infringing ITEM-2 118₂ is a usable copy of ITEM-2, and modified ITEM-2 212 is an unusable copy of ITEM-2. When download-infringing user 202 searches for ITEM-2 through network 116, it detects four copies of ITEM-2: infringing ITEM-2 118₂, and three copies of modified ITEM-2 212 in each of distributed host users 206, 208 and 210.

Directory 114 supplies download-infringing user 202 with information respective of the characteristics of infringing ITEM-2 118₂ and the three copies of modified ITEM-2 212, such as title, production date and file size. Since the characteristics of infringing ITEM-2 118₂ and the three copies of modified ITEM-2 212 are substantially identical, download-infringing user 202 can not differentiate between the four items and can not identify the three modified (unusable) ITEM-2's 212. In this situation, the probability that download-infringing user 202 shall download a usable copy of ITEM-2 (i.e., infringing ITEM-2 118₂) in one try, is only ¼ (i.e., 25%).

Download-infringing user 202 can identify modified copies of ITEM-2 212 according to the attributes of each of the distributed host users 206, 208 and 210. These attributes can be network interface card (NIC) identification, logical user name, the network service provider, network protocol address, and the like. In this manner, download-infringing user 202 can identify infringing ITEM-2 118₂, by elimination. Each of the distributed host users 206, 208 and 210 can periodically (e.g., every hour, once a week, or once a month), change the attributes thereof. Hence, the probability that download-infringing user 202 identifies the modified copies of ITEM-2 212, is substantially reduced.

When sniffing user 102 (FIG. 1), searches infringing ITEM-2 118₂ in network 116, directory 114 can identify sniffing user 102 according to the attributes thereof, and deny access of network 116 to sniffing user 102. Sniffing user 102 can periodically change the attributes thereof, thereby escaping identification by directory 114.

Each of the distributed host users 206, 208 and 210 can upload modified ITEM-2 212 to download-infringing user 202, at the request thereof, while varying the Quality of Service (QoS), provided to download-infringing user 202, during the upload process. For example, during the first few minutes of transmission, distributed host user 206 can upload modified ITEM-2 212 to download-infringing user 202, at a high rate of 50 kBytes/second. If, for example, the size of ITEM-2 212 is 15 Mbytes, then, the download should take about five minutes. Distributed host user 206 can then reduce the transfer rate, for the remainder of modified ITEM-2 212, to 1 kBytes/second, thereby drastically reducing the QoS and saving considerable bandwidth.

Distributed host user 206 initially uploads modified ITEM-2 212 at a high rate, in order to convince download-infringing user 202 that the QoS of the connection with distributed host user 206 is high and that it can download ITEM-2 212 fairly rapidly. Download-infringing user 202 continues the supposedly rapid download, only to determine at a later time, if at all, that the QoS of the connection has dropped considerably during the download of the remainder of modified ITEM-2 212.

Distributed host user 206 lowers the transmission bit rate of modified ITEM-2 212, in order to balance the load thereof. In this manner, distributed host user 206 can simultaneously upload modified ITEM-2 212 to download-infringing users 202 and 202 over the same high bandwidth channel and during high traffic periods.

If distributed host user 206 uploads modified ITEM-2 212 at an initial high bit rate and subsequent low bit rate, then download-infringing user 202 determines during the downloading process, that modified ITEM-2 212 is a useless copy of ITEM-2. Download-infringing user 202 might identify modified ITEM-2 212 as such and terminate the remaining download. In order to prevent download-infringing user 202 from identifying modified ITEM-2 212, distributed host user 206 alternates between the high and the low transmission bit rates. Thus, download-infringing user 202 determines that the varying transmission bit rate is an outcome of normal variations in traffic.

In some networks the users are requested to report the type of connection which links them to the network, to other nodes. A remote user or a server sends a bandwidth request to the user, which in turn replies with a bit rate value or connection type (e.g., cable, T1, T3, ISDN, 10BaseT, 100BaseT, and the like). According to a further aspect of the invention, distributed host user 206 uses this mechanism to mislead downloading infringing users by reporting a certain bit rate, which may appeal to them, and then upload files at significantly reduced bit rates, thereto. With respect to FIG. 3, distributed host user 206 can report to directory 114, the type of connection thereof to network 116, via the downloading application. However, distributed host user 206 uploads modified ITEM-2 212 to download-infringing user 202 at a bit rate different than the one previously reported to directory 114. For example, distributed host user 206 can report to directory 114 that the connection thereof to network 116 is via a T1 trunk at 1.544 Mbits/second. However, distributed host user 206 uploads modified ITEM-2 212 to download-infringing user 202 at less than one kbit/second and vice versa.

According to another aspect of the present invention, directory 114 is a conventional search engine, such as Yahoo!, Alta Vista, Galaxy, GO.COM, and the like. In this case, when download-infringing user 202 searches for ITEM-2 using the search engine, the search result indicates that infringing ITEM-2 1182 is located in share-infringing user 112 and a copy of modified ITEM-2 212 is located in each of distributed host users 206, 208 and 210.

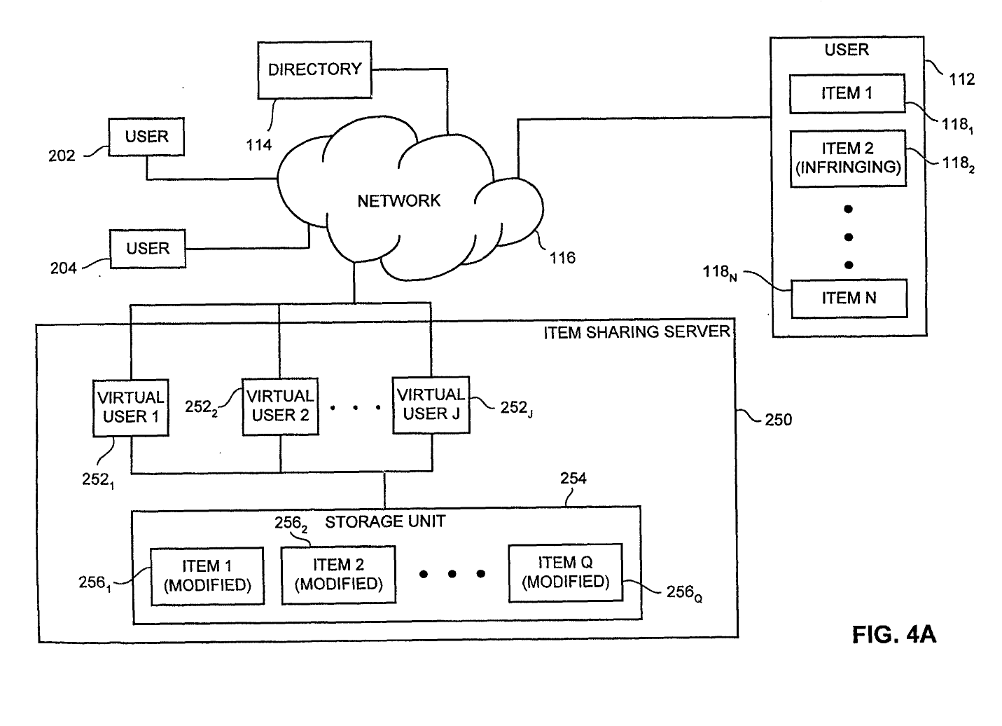

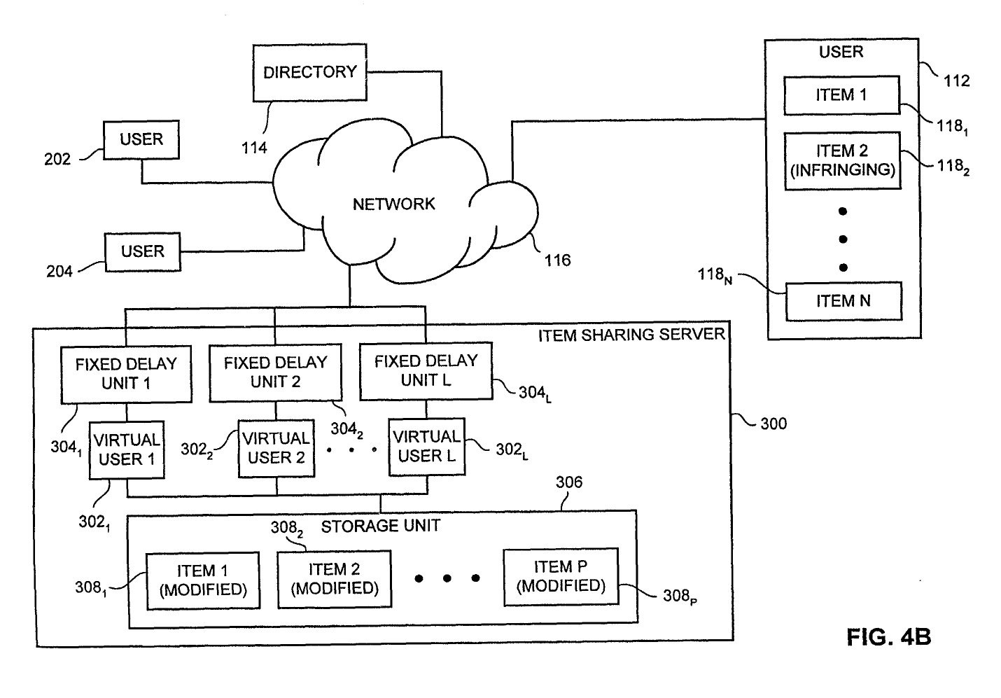

Reference is now made to FIG. 4A. FIG. 4A is a schematic illustration of an item sharing server, generally referenced 250, constructed and operative in accordance with another preferred embodiment of the present invention. Item sharing server 250 includes a plurality of virtual users 252₁, 252₂ and 252_{J} and a storage unit 254. Storage unit 254 includes a plurality of different modified items: ITEM-1 256₁, ITEM-2 256₂ and ITEM-Q 256_{Q} (Q is not necessarily equal to N of ITEM-N 118_{N}).

Each of virtual users 252₁, 252₂ and 252_{J} is a software application which runs in item sharing server 250. However, over network 116 each of virtual users 252₁, 252₂ and 252_{J} is perceived as a hardwired user such as a desktop, laptop, workstation, mobile unit, network user applications, and the like, which has a unique URL, network protocol address (e.g. IP address), user name, MAC address, and the like.

Each of virtual users 252₁, 252₂ and 252_{J}, download-infringing users 202, 204, share-infringing user 112 and directory 114 are connected to network 116. Each of virtual users 252₁, 252₂ and 252_{J} is connected to storage unit 254. When download-infringing user 202 searches for ITEM-2 (not shown), directory 114 notifies download-infringing user 202 that a copy of ITEM-2 is located in each of the J virtual users 252₁, 252₂ and 252_{J}, and a copy of ITEM-2 1182 is located in share-infringing user 112. It is noted that one ITEM-2 2562 corresponds with each of the J virtual users 252₁, 252₂ and 252_{J}. Thus, the search result lists ITEM-2 256₂, J times, once for each of virtual users 252₁, 252₂ and 252_{J}, and lists ITEM-2 118₂ once for share-infringing user 112.

The characteristics of each of the J modified (unusable) ITEM-2's 256₂, which supposedly resides in each of the J virtual users 252₁, 252₂ and 252_{J}, is identical with the characteristics of infringing (usable) ITEM-2 118₂. Thus, download-infringing user 202 can not determine which of the items in the search result are the modified (unusable) ones. In this case, the probability that download-infringing user 202 downloads infringing (usable) ITEM-2 118₂ in the first try, is n/(n+J), where n denotes the number of infringing copies of ITEM-2. The greater the number of virtual users 252₁, 252₂ and 252_{J}, the lower the probability that download-infringing user 202 downloads the infringing (usable) ITEM-2 118₂ in the first try.

When download-infringing user 202 searches for ITEM-1 118₁, the search result provided by directory 114 indicates that one ITEM-1 118₁ resides in share-infringing user 112 and J copies of ITEM-1 256₁, reside in each of virtual users 252₁, 252₂ and 252_{J}. The characteristics listed in the search result for ITEM-1 181 is identical with the characteristics listed for each of the J ITEM-1's 256₁. Thus, download-infringing user 202 can not determine which of the items are the modified (unusable) ones, only by cross-examining the characteristics of the items in the list.

The term “local user” herein below, refers to a user who searches for an item in a network, in order to download the item from another user connected to the network (herein below referred to as “remote user”). When a local user initiates a search for an item, the directory supplies a search result to the local user. The search result includes the characteristics of the items found, along with the URL, network protocol address, user name, media access control (MAC) address, and the like, of each of the remote users which includes an item. The downloading application running in the local user, initiates a “ping command” to the URL, network protocol address, user name, MAC address, and the like, of each of these remote users. When a remote user receives the ping command, it sends back an “ACK” signal to the local user. The local user application measures the time for the roundtrip from the instant it initiates the ping command until the time it receives the ACK signal and produces a “ping”. The ping time provides an indication to quality of the connection between the ping initiating node and the ping destination node. Thus, in order to expedite the download procedure, the local user can download a selected item from the remote user having the lowest ping in the list.

When the local user transmits a ping command to a remote user, a switched virtual connection (SVC) is established between the two users. When the local user initiates connection with the remote user to download an item, another SVC is established between the two, which can be different from the SVC established for transmitting the ping command. In this sense, the ping time indicates to the local user the download time from the remote user relative to other remote users, while this indication is true up to a certain probability.

Since the pings for the same remote user or remote users located substantially close, are equal, the local user can employ the pings, to determine whether two or more items are located in the same remote user. Since virtual users 252₁, 252₂ and 252_{J} are physically located at the same site (i.e., the physical location of item sharing server 250), the pings of virtual users 252₁, 252₂ and 252_{J} are essentially identical, for example 250 ms. If share-infringing user 112 is physically located at a location different than item sharing server 250, then the ping of share-infringing user 112 is different than the ping of virtual users 252₁, 252₂ and 252_{J} and it is for example, 300 ms. Download-infringing user 202 can determine that a plurality of J modified copies of ITEM-2 256₂ having identical pings of 250 ms, all reside in the same user, and conclude that all of J modified copies ITEM-2 256₂ are indeed modified and thus unusable. Download-infringing user 202 can refrain from downloading any of these J modified copies of ITEM-2 256₂, and instead download infringing (usable) ITEM-2 118₂ from share-infringing user 112. Thus, when download-infringing user 202 employs the ping command in selecting an item, she may be able to differentiate an infringing copy from a modified one and hence increase the probability for downloading a usable item. It is noted that searching server 100 (FIG. 1), production server 150 (FIG. 2) and item sharing server 250 (FIG. 4A), or a combination thereof, can be integrated in one unit.

Reference is now made to FIG. 4B, which is a schematic illustration of an item sharing server, generally referenced 300, constructed and operative in accordance with a further preferred embodiment of the present invention. Item sharing server 300 includes a plurality of virtual users 302₁, 302₂ and 302_{L}, a plurality of fixed delay units 304₁, 304₂ and 304_{L} and a storage unit 306. Storage unit 306 includes a plurality of different modified items: ITEM-1 308₁, ITEM-2 308₂ and ITEMP 308_{P} (P is not necessarily equal to N in ITEM-N 118_{N}).

Fixed delay unit 304₁ is connected to network 116 and to virtual user 302₁. Fixed delay unit 304₂ is connected to network 116 and to virtual user 302₂. Fixed delay unit 304_{L} is connected to network 116 and to virtual user 302_{L}. Virtual users 302₁, 302₂ and 302_{L} are connected to storage unit 306. Download-infringing users 202, 204, share-infringing user 112 and directory 114 are connected to network 116.

Each of fixed delay units 304₁, 304₂ and 304_{L} is a unit which responds to a ping command with a delay. The delay of each of fixed delay units 304₁, 304₂ and 304_{L} is constant, but different from the rest. For example, the delay of each of fixed delay units 304₁, 304₂ and 304_{L} is 45 ms, 10 ms and 145 ms, respectively. When download-infringing user 204 initiates a ping command to virtual user 302₁, fixed delay unit 304₁ applies a delay of 45 ms and virtual user 302₁ sends back an ACK₁ signal to download-infringing user 204, after a delay of 45 ms. When download-infringing user 204 initiates a ping command to virtual user 302₂, fixed delay unit 304₂ applies a delay of 10 ms and virtual user 302₂ sends back an ACK₂ signal to download-infringing user 204, after a delay of 10 ms. When download-infringing user 204 initiates a ping command to virtual user 302_{L}, fixed delay unit 304_{L} applies a delay of 145 ms and virtual user 302_{L} sends back an ACKL signal to download-infringing user 204, after a delay of 145 ms.

Share-infringing user 112 is located at a location substantially different than item sharing server 300, relative to download-infringing user 204. The ping of share-infringing user 112 is for example, 350 ms.

When download-infringing user 204 searches for ITEM-2 (not shown), the search result provided by directory 114 indicates that one ITEM-2 118₂ (which is usable), resides in share-infringing user 112 and L copies of ITEM-2 308₂, reside in each of virtual users 302₁, 302₂ and 302_{L}, The characteristics listed in the search result for ITEM-2 118₂ are identical with the characteristics listed for each of the L copies of ITEM-2 308₂.

The downloading application running in download-infringing user 204 indicates a ping of 295 ms for modified ITEM-2 308₂ of virtual user 302₁, a ping of 260 ms for modified ITEM-2 308₂ of virtual user 302₂, a ping of 395 ms for modified ITEM-2 308₂ of virtual user 302_{L} and a ping of 350 ms for infringing ITEM-2 118₂ of share-infringing user 112. By comparing the pings of virtual users 302₁, 302₂ and 302_{L} and share-infringing user 112, download-infringing user 204 concludes that virtual users 302₁, 302₂ and 302_{L} and share-infringing user 112 are all different users physically located at different locations and also that the L copies of modified ITEM-2 308₂ are supposedly usable. In this case, the probability that download-infringing user 204 downloads infringing (usable) ITEM-2 118₂ in the first try, is n/(n+L), where n denotes the number of infringing copies of ITEM-2. The greater the number of virtual users 302₁, 302₂ and 302_{L}, the lower the probability that download-infringing user 204 downloads the infringing (usable) ITEM-2 118₂ in the first try.

Download-infringing user 204 can identify virtual users 302₁, 302₂ and 302_{L} as such, by analyzing the search result and determining that each of virtual users 302₁, 302₂ and 302_{L} points to the same plurality of items (i.e., ITEM-1 308₁, ITEM-2 308₂ and ITEM-P 308_{P}). To circumvent this problem, each of virtual users 302₁, 302₂ and 302_{L} can share a different set of the modified items stored in storage unit 306. For example, virtual user 302₁ shares ITEM-1 308₁, ITEM-3 (not shown) and ITEM-4 (not shown), virtual user 302₂ shares ITEM-2 308₂, ITEM-9 (not shown), ITEM-11 (not shown) and ITEM-15 (not shown) and virtual user 302_{L} shares ITEM-20 (not shown), ITEM-29 (not shown) and ITEM-P 308_{P}.

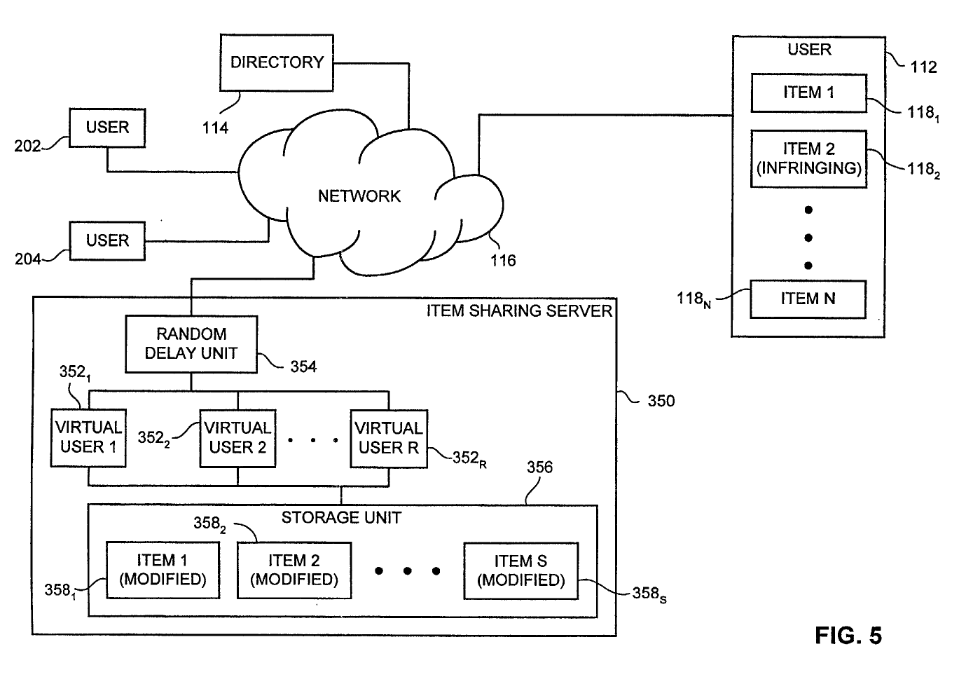

Reference is now made to FIG. 5, which is a schematic illustration of an item sharing server, generally referenced 350, constructed and operative in accordance with another preferred embodiment of the present invention. Item sharing server 350 includes a plurality of virtual users 352₁, 352₂ and 352_{R}, a random delay unit 354 and a storage unit 356. Storage unit 356 includes a plurality of different modified items: ITEM-1 358₁, ITEM-2 358₂ and ITEM-S 358_{S} (S is not necessarily equal to N in ITEM-N 118_{N}).

Random delay unit 354 is connected to network 116 and to virtual users 352₁, 352₂ and 352_{R} Virtual users 352₁, 352₂ and 352_{R}, are connected to storage unit 356. Download-infringing users 202, 204, share-infringing user 112 and directory 114 are connected to network 116. Random delay unit 354 selects a time delay, randomly.

When download-infringing user 202 searches for ITEM-2 (not shown), the search result provided by directory 114 indicates that one ITEM-2 118₂, resides in share-infringing user 112 and R copies of ITEM-2 358₂, reside in each of virtual users 352₁, 352₂ and 352_{R}. Download-infringing user 204, then initiates ping commands to share-infringing user 112, and to virtual users 352₁, 352₂ and 352_{R}.

For example, when download-infringing user 202 initiates a ping command to virtual user 352₁, random delay unit 354 randomly selects a time delay of 200 ms and thus virtual user 352₁ sends back an “ACK₁” signal to download-infringing user 202 after a delay of 200 ms. When download-infringing user 202 initiates a ping command to virtual user 352₂, random delay unit 354 randomly selects a time delay of 9 ms and thus virtual user 352₂ sends back an “ACK₂” signal to download-infringing user 202 after a delay of 9 ms. When download-infringing user 202 initiates a ping command to virtual user 352_{R}, random delay unit 354 randomly selects a time delay of 55 ms and thus virtual user 352_{R} sends back an “ACK_{R}” signal to download-infringing user 202 after a delay of 55 ms.

Share-infringing user 112 is located at a location substantially different than item sharing server 350, relative to download-infringing user 202. The ping of share-infringing user 112 is for example, 500 ms. By inspecting the ping for share-infringing user 112 and the pings for virtual users 352₁, 352₂ and 352_{R}, download-infringing user 202 concludes that infringing ITEM-2 118₂ and the R modified ITEM-2's 358₂ each resides in a different user. Thus, download-infringing user 202 can not determine which of ITEM-2 118₂, and the R modified ITEM-2's 358₂ is the unmodified (usable) copy of ITEM-2.

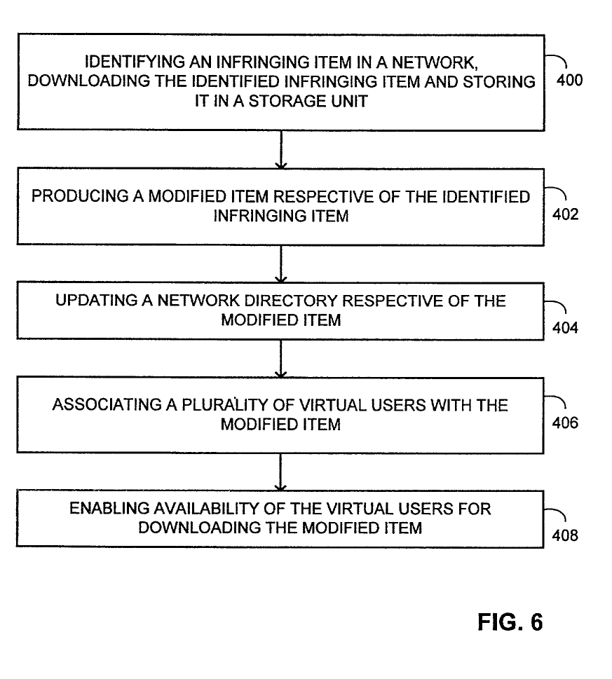

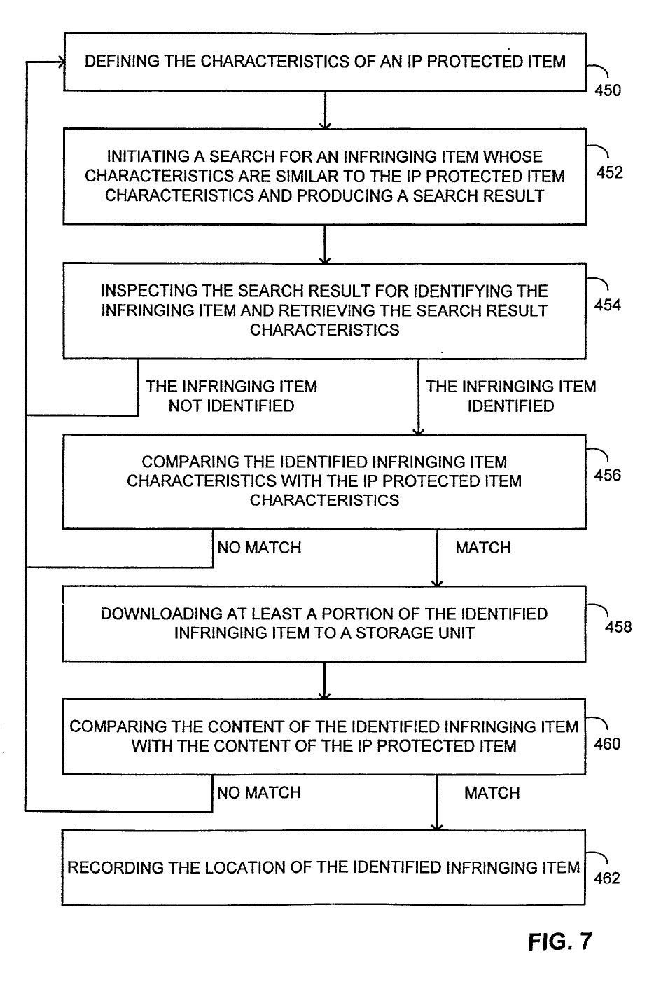

Reference is now made to FIG. 6, which is a schematic illustration of a method for proliferating unusable copies of an item in a network, operative in accordance with a further preferred embodiment of the present invention. In step 400, an infringing item in a network is identified, the infringing item is downloaded and stored in a storage unit. With reference to FIG. 1, sniffing user 102 searches network 116 for infringing ITEM-2 118₂. Directory 114 provides sniffing user 102 with a search result which includes ITEM-2 118₂, sniffing user 102 identifies ITEM-2 118₂ as the infringing item, and determines that infringing ITEM-2 118₂ resides in share-infringing user 112. Sniffing user 102 downloads infringing ITEM-2 118₂ from share-infringing user 112 and stores infringing ITEM-2 118₂ in a storage unit (not shown). Step 400 is described in detail herein below in conjunction with FIG. 7.

In step 402, a modified item, respective of the identified infringing item, is produced. With reference to FIG. 2, processor 156 produces modified ITEM-2 154 according to at least a portion of IP protected ITEM-2 158. Alternatively, processor 156 produces modified ITEM-2 154 according to at least a portion of infringing ITEM-2 118₂. Processor 156 produces modified ITEM-2 154, such that the characteristics thereof (e.g., title, file size and production date) are substantially identical with the characteristics of infringing ITEM-2 118₂. However, processor 156 produces modified ITEM-2 154 in such a manner that modified ITEM-2 154 can not be used the way infringing ITEM-2 118₂ or IP protected ITEM-2 158 is generally used in its entirety. For example, modified ITEM-2 154 can contain the same content as of IP protected ITEM-2 158, while selected segments of the content are located out of sequence.

A user which receives the characteristics of modified ITEM-2 154 in a search result, can not determine that modified ITEM-2 154 is indeed modified and useless, by inspecting the characteristics thereof, alone. Neither after downloading modified ITEM-2 154 (which demands substantial resources such as computer time, bandwidth fees, and the like), can the user determine that modified ITEM-2 154 is useless. When the modified item is a media item (video, audio or readable files such as e-books), only after starting to use a considerable portion of modified ITEM-2 154 does the user determine that modified ITEM-2 154 is useless.

In step 404, a network directory is updated, respective of the modified item. With reference to FIG. 2, production server 150 updates directory 114 by reporting to directory 114 the characteristics of modified ITEM-2 154 and the URL, network protocol address, user name, MAC address, and the like, of virtual user 152.

In step 406, a plurality of virtual users are associated with the modified item. With reference to FIG. 4B, item sharing server 300 provides association between virtual users 302₁, 302₂ and 302_{L}, and modified ITEM-2 308₂ by storing modified ITEM-2 308₂ in storage unit 306. An outcome of this association is that in a list included in directory 114, when virtual users 302₁, 302₂ and 302_{L} are connected to network 116, modified ITEM-2 308₂ (including the characteristics thereof) points to each of virtual users 302₁, 302₂ and 302_{L}, Moreover, modified copies of other items such as modified ITEM-1 308₁ and modified ITEM-P 308_{P} are associated with each of virtual users 302₁, 302₂ and 302_{L}, In step 408, the availability of the virtual users for downloading the modified item, is enabled. With reference to FIG. 4B, item sharing server 300 connects each of virtual users 302₁, 302₂ and 302_{L} to network 116. Thus, other users connected to network 116, such as download-infringing users 202, 204 and share-infringing user 112, can download modified ITEM-2 308₂ and other modified items such as modified ITEM-1 308₁ and modified ITEM-P 308_{P}.

Reference is now made to FIG. 7, which is a schematic illustration of step 400 of FIG. 6, operative in accordance with another preferred embodiment of the present invention. In step 450, the characteristics of an IP protected item are defined. With reference to FIG. 1, sniffing user 102 retrieves at least one of the characteristics (e.g., title, creation date, file size, and the like) of an IP protected item, from characteristics database 104.

In step 452, a search is initiated for an infringing item whose characteristics are similar to the IP protected item characteristics and a search result is produced according to the search. With reference to FIG. 1, sniffing user 102 searches network 116 for infringing ITEM-2 118₂ whose characteristics are similar to the characteristics of the IP protected item, which were defined in step 450. It is noted that directory 114 can identify more than one infringing item whose characteristics are similar to the IP protected item characteristics.

For example, if sniffing user 102 provides directory 114 with the title of an IP protected item, such as “Donald Duck”, then the search result can include the items with the similar titles “Donald Duck at Sea”, “Donald Duck in Jail” and “Donald Duck in Africa” as the putative infringing items.

In this case, with reference to FIG. 1, “Donald Duck at Sea” is ITEM-1 118₁, “Donald Duck in Jail” is infringing ITEM-2 118₂ and “Donald Duck in Africa” is ITEM-N 118_{N} In step 454, the search result is inspected for identifying the infringing item and the characteristics listed in the search result, are retrieved. With reference to FIG. 1, sniffing user 102 inspects the search result. The search result includes the characteristics of infringing ITEM-2 118₂, such as the title (i.e., “Donald Duck in Jail”), the producer (i.e., “Walt Disney Productions”), and the type (i.e., “Video”). Sniffing user 102 retrieves the characteristics listed in the search result, for identifying the infringing item, by referring for example, to characteristics database 104.

Sniffing user 102 determines that share-infringing user 112 owns a license to use ITEM-1 118₁ and ITEM-N 118_{N}, but owns no license for using ITEM-2 118₂. Thus, sniffing user 102 determines that ITEM-2 118₂ is an infringing copy of ITEM-2 (i.e., “Donald Duck in Jail”) and the method proceeds to step 456. If sniffing user 102 identifies no infringing items in the search result, then the method returns back to step 450, for defining the characteristics for a new IP protected item.

In step 456, the identified infringing item characteristics are compared with the IP protected item characteristics. With reference to FIG. 1, sniffing user 102 compares the characteristics of ITEM-2 118₂, with the characteristics of IP protected ITEM-2. The characteristics of ITEM-2 118₂ were retrieved from the search result in step 454 and the characteristics of IP protected ITEM-2 are retrieved from characteristics database 104. If the two characteristics do not match, then the method returns back to step 450, for defining the characteristics for a new IP protected item.

If these two characteristics match, then the method can end the detection phase or proceed to step 458, which increases the identification certainty. In step 458, at least a portion of the identified infringing item is downloaded to a storage unit. With reference to FIG. 1, sniffing user 102 downloads at least a portion of infringing ITEM-2 118₂ to a storage unit (not shown) located in searching server 100. Sniffing user 102, then stores the identified infringing item characteristics in a storage unit and records the location (i.e., the URL, network protocol address, user name, MAC address, and the like of share-infringing user 112) of ITEM-2 118₂, in the storage unit (step 462).

In step 460, the content of the identified infringing item, is compared with the content of the IP protected item. Many methods for comparing media content can be used for this step. In the example set forth in FIG. 1, sniffing user 102 produces a content based signature for at least a portion of the downloaded content of infringing ITEM-2 118₂, and retrieves the signature of ITEM-2 (i.e., “Donald Duck in Jail”), from signature database 106. Sniffing user 102, then compares the produced signature with the retrieved signature. If the signature of the IP protected ITEM-2, and the signature of infringing ITEM-2 118₂ do not match, then the method returns back to step 450, for defining the characteristics for a new IP protected item. If the signature of the IP protected ITEM-2, and the signature of infringing ITEM-2 118₂ match, then the method proceeds to step 460.

It is noted that steps 458 and 460 merely provides confirmation that the content of the identified infringing item is indeed infringing. Hence, when a low level of certainty is required, steps 458 and 460 can be discarded, whereby an infringing item is identified merely according to immediate characteristics such as item title, item size and item type.

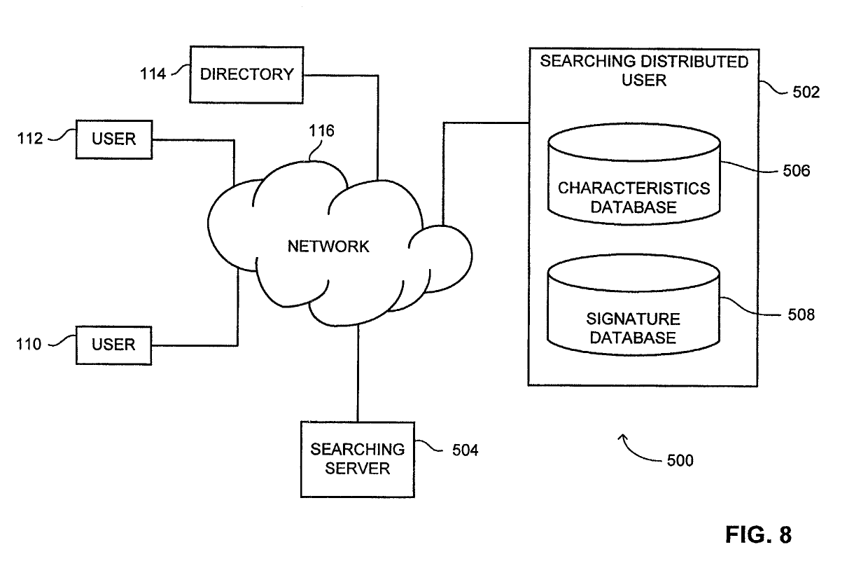

Reference is now made to FIG. 8, which is a schematic illustration of a computer system, generally referenced 500, constructed operative in accordance with a further preferred embodiment of the present invention. System 500 includes a searching distributed user 502 and a searching server 504. Searching distributed user includes a characteristics database 506 and a signature database 508.

Searching distributed user is a workstation, desktop, laptop, mobile unit, network user applications, and the like. Searching server 504, characteristics database 506 and signature database 508 are similar to searching server 100 (FIG. 1), characteristics database 104 and signature database 106, respectively. Characteristics database 506 and signature database 508 include the characteristics and the signatures, respectively, of selected IP protected items (not shown). Searching distributed user 502, searching server 504, user 110, share-infringing user 112 and directory 114 are connected to network 116.

Searching server 504 uploads characteristics database 506 and signature database 508 to searching distributed user 502, via network 116. Alternatively, searching server 504 delivers a hard copy of characteristics database 506 and signature database 508 to searching distributed user 502, in the from of CD-ROM, floppy disk, flash memory, and the like.

Searching distributed user 502 searches network 116 for an infringing copy of a selected IP protected item, for example ITEM-2 (not shown), according to the characteristics thereof. According to a search result which searching distributed user 502 receives from directory 114, infringing ITEM-2 118₂ (FIG. 1) resides in share-infringing user 112. Searching distributed user 502 downloads at least a portion of infringing ITEM-2 118₂ and produces a signature for infringing ITEM-2 118₂ according to downloaded infringing ITEM-2 118₂. Searching distributed user 502 retrieves the signature of IP protected ITEM-2 from signature database 508 and compares this signature with the produced signature of infringing ITEM-2 118₂. If the two signatures match, then searching distributed database 502 uploads the characteristics of infringing ITEM-2 118₂ to searching server 504, via network 116. Searching server 504, uploads to searching distributed user 502, an IP protected item and a license to use the IP protected item, as a reward for the search which searching distributed user 502 performs.

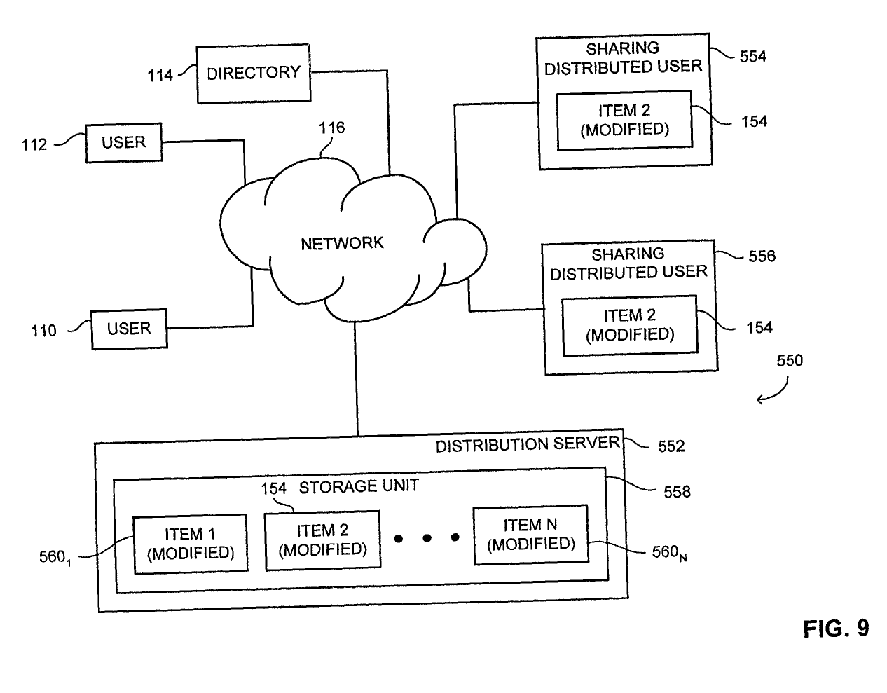

Reference is now made to FIG. 9, which is a schematic illustration of a computer system, generally referenced 550, constructed operative in accordance with another preferred embodiment of the present invention. System 550 includes a distribution server 552 and sharing distributed users 554 and 556. Distribution server 552 includes a storage unit 558. Storage unit 558 includes a plurality of modified items: modified ITEM-1 560₁, modified ITEM-2 154 and modified ITEM-N 560_{N}. Modified ITEM-2 154 is a modified copy of infringing ITEM-2 118₂ (FIG. 1). Alternatively, modified ITEM-2 154 is a modified copy of IP protected ITEM-2 158 (FIG. 2). Modified ITEM-2 154 is previously produced by production server 150 (FIG. 2). The size of modified ITEM-2 154 is substantially equal to the size of infringing ITEM-2 118₂. Sharing distributed users 554 and 556 are located at substantially different physical locations.

Each of sharing distributed users 554 and 556 is a workstation, desktop, laptop, mobile unit, network user applications, and the like. Sharing distributed users 554 and 556, distribution server 552, user 110, share-infringing user 112 and directory 114 are connected to network 116.

Distribution server 552 uploads modified ITEM-2 154 to sharing distributed users 554 and 556, via network 116. Alternatively, distribution server 552 uploads modified ITEM-2 154 to sharing distributed users 554 and 556, during an idle period (i.e., when the communication load in network 116 is low and the cost of bandwidth is low). Further alternatively, distribution server 552 uploads to sharing distributed users 554 and 556, a portion of the beginning of infringing ITEM-2 118₂, and a supplementary material. Each of sharing distributed users 554 and 556, then produces a combined modified item (not shown) for infringing ITEM-2 118₂, by combining the beginning portion of ITEM-2 with a plurality of the supplementary material, so that the size of the combined modified item is substantially equal to infringing ITEM-2 118₂. Each of sharing distributed users 554 and 556, then stores the combined modified item in a storage unit therein.

It is noted that the beginning portion of ITEM-2 and the supplementary material, are each in a format which allows a supplementary material to be linked to the beginning portion and each supplementary material to be linked to the previous supplementary material. Thus, the combined modified item is in a format known in the art, Such as MIDI, WAV, AVI, MPEG, JPEG, ASCII, TIFF, GIF, PDF, RTF, bitmap, and the like, and the combined modified item can be downloaded from one user to another, connected to a network.

For example, the size of ITEM-2 118₂ is 600 MB, the size of the beginning portion of ITEM-2 is 30 MB and the size of the supplementary material is 5 MB. The combined modified item, then includes the beginning portion of ITEM-2 118₂ (30 MB), while the remainder 570 MB thereof (600−30=570), includes the supplementary material recurring 114 (570/5=114) times. In this case, distribution server 552 uploads only 35 MB for each of sharing distributed users 554 and 556 to produce the combined modified item, instead of uploading modified ITEM-2 154 whose size is 600 MB (i.e., the size of infringing ITEM-2 118₂).

Alternatively, distribution server 552 uploads to each of sharing distributed users 554 and 556, a plurality of different segments of infringing ITEM-2 118₂, for example, each segment having a size of 40 MB. Distribution server 552, uploads to each of sharing distributed servers 554 and 556, four segments of infringing ITEM-2 118₂ (a total of 160 MB), instead of uploading the entire modified ITEM-2 154, whose size is for example, 600 MB. In this case, each of sharing distributed users 554 and 556, produces an out-of-sequence modified item (not shown), by repetitively combining the four segments out-of-sequence, such that the size of the out-of-sequence modified item is substantially equal to the size of infringing ITEM-2 118₂. Each of sharing distributed users 554 and 556, then stores the out-of-sequence modified item in a storage unit therein.

It is noted that each of the different segments of infringing ITEM-2 118₂ is in a format which allows one segment to be linked to the previous segment. Thus, the out-of-sequence modified item is in a format known in the art, such as MIDI, WAV, AVI, MPEG, JPEG, ASCII, TIFF, GIF, PDF, RTF, bitmap, and the like, and the out-of-sequence modified item can be downloaded from one user to another, connected to a network.

When user 110 initiates a search for ITEM-2 118₂ (FIG. 1) in network 116, directory 114 provides user 110 with a search result. The search result indicates that a copy of ITEM-2 118₂ resides in share-infringing user 112, a copy of ITEM-2 154 resides in sharing distributed user 554 and another copy of ITEM-2, referenced 154 resides in sharing distributed user 556.

Since the characteristics of ITEM-2 118₂ and the two ITEM-2's 154 are identical, user 110 can not determine that the two copies of ITEM-2 154 are modified and thus unusable. Furthermore, since the physical locations of share-infringing user 112 and sharing distributed users 554 and 556 are different, the pings of these users are different. Thus, user 110 can not determine which of ITEM-2's 118₂ and 154 are modified and unusable, by examining the characteristics and pings thereof, alone.

When user 110 transmits a request for example, to sharing distributed user 554 to download modified ITEM-2 154 therefrom, then sharing distributed user 554 uploads to user 110 modified ITEM-2 154, which distribution server 552 had previously uploaded to sharing distributed user 554. Alternatively, sharing distributed user 554 uploads to user 110 the combined modified item, from the storage unit therein. Further alternatively, sharing distributed user 554 uploads to user 110 the out-of-sequence modified item, from the storage unit therein.

Alternatively, sharing distributed user 554 uploads to user 110 the beginning portion of infringing ITEM-2 118₂ and then a selected number of the supplementary material, such that the amount of uploaded data is substantially equal to the size of infringing ITEM-2 118₂. Alternatively, sharing distributed user 554 uploads to user 110 a selected number of the different segments of infringing ITEM-2 118₂, out-of-sequence, such that the amount of uploaded data is substantially equal to the size of infringing ITEM-2 118₂.

Further alternatively, sharing distributed user 554 uploads the different segments of infringing ITEM-2 118₂, out-of-sequence, for as long as user 110 is connected to sharing distributed user 554 via network 116 and for as long as the downloading application is running in both user 110 and sharing distributed user 554. Alternatively, when user 110 opens infringing ITEM-2 118₂, infringing ITEM-2 118₂ runs properly during the beginning portion thereof, but ceases to run thereafter, or runs improperly thereafter.

Further alternatively, when sharing distributed user 554 uploads modified ITEM-2 154 to user 110, sharing distributed user 554 determines the e-mail address of user 110 according to the user name thereof. Sharing distributed user 554 then sends an e-mail message to user 110. In this e-mail message, sharing distributed user 554 notifies user 110 that it has infringed IP protected rights, reports the means by which user 110 can obtain a legitimate of infringing ITEM-2 118₂, posts an advertisement, a commercial promotion, and the like.

According to another aspect of the present invention, other sharing distributed users (not shown), can be connected to each of sharing distributed users 554 and 556, via Internet Protocol (IP) multicasting. Each of sharing distributed users 554 and 556 uploads modified ITEM-2 154 to each of these other sharing distributed users connected thereto. Thus, the number of the sharing distributed users which include modified ITEM-2 154 can be increased considerably, at a relatively low bandwidth cost. Furthermore, periodically, for example once a year, distributed server 552 deletes those modified items from each of sharing distributed users 554 and 556, which are no longer being downloaded with sufficient frequency, by user 110 or share-infringing user 112.

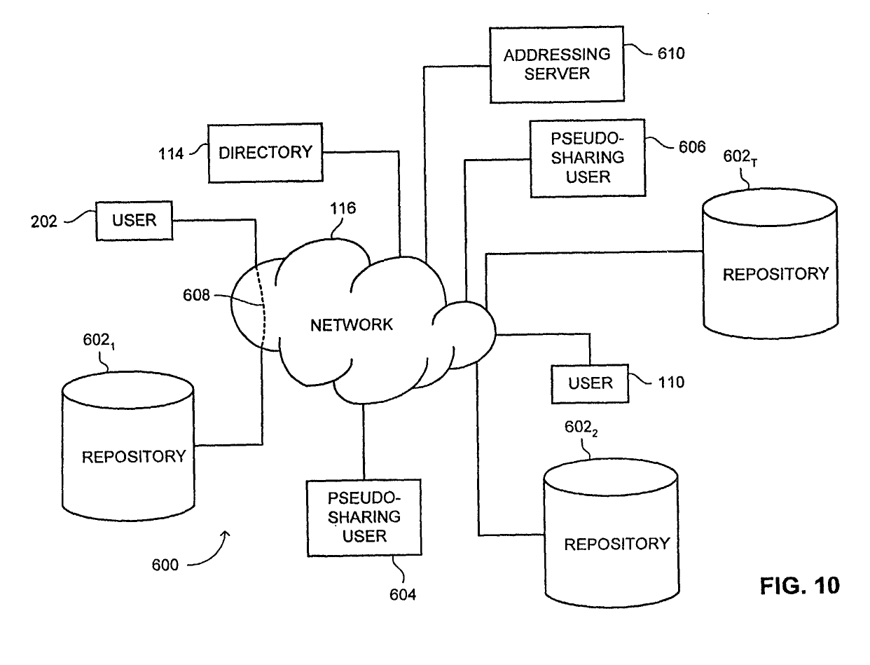

Reference is now made to FIG. 10, which is a schematic illustration of a computer system, generally referenced 600, constructed operative in accordance with a further preferred embodiment of the present invention. System 600 includes a plurality of repositories 602₁, 602₂ and 602_{T}, an addressing server 610 and a plurality of pseudo-sharing users 604 and 606. Repositories 602₁, 602₂ and 602_{T}, pseudo-sharing users 604 and 606, addressing server 610, user 110, download-infringing user 202 and directory 114 are connected to network 116. It is noted that repositories 602₁, 602₂ and 602_{T} include internal network interfaces (not shown) for connecting to network 116.

The term “peer brokering” herein below, refers to a method by which a first user connected to a network, provides connection between a second user and a third user via the network, when the second user connects to the first user. The first user, then tears down its connection with the second user, and instead connects the second user with the third user. The second user perceives that it is communicating with the first user, while the second user is actually communicating with the third user.

Each of pseudo-sharing users 604 and 606 is a workstation, desktop, laptop, mobile unit, network user applications, and the like. Each of pseudo-sharing users 604 and 606 includes a peer brokering function. Each of pseudo-sharing users 604 and 606 includes a list of modified items (not shown). Each of repositories 602₁, 602₂ and 602_{T}, includes the content of all or a portion of the modified items listed in each of pseudo-sharing users 604 and 606. Addressing server 610 includes a characteristics list of all the modified items which are located in repositories 602₁, 602₂ and 602_{T}. Each entry in the characteristics list includes a pointer to the specific location in the repository which includes the content of the modified item recorded in the entry.

When download-infringing user 202 searches for a selected item in network 116, directory 114 provides download-infringing user 202 with a search result. The modified items list of pseudo-sharing user 604 includes the selected item. Therefore, the search result indicates that the selected item resides in pseudo-sharing user 604. By running the downloading application, download-infringing user 202 establishes connection with pseudo-sharing user 604 and initiates a request to download the selected item from pseudo-sharing user 604.

The following is a peer brokering scenario according to another aspect of the invention. Download-infringing user 202 transmits a request message to pseudo-sharing user 604 to download an item. In return, pseudo-sharing user 604 directs download-infringing user 202 to one of repositories 602₁, 602₂ and 602_{T}, for downloading the requested item therefrom. It is noted that this directing procedure is seamless to download-infringing user 202.

Pseudo-sharing user 604 transmits a peer brokering message to addressing server 610 and tears down its connection with download-infringing user 202. This peer brokering message includes the network address of download-infringing user 202 and the characteristics of the requested item. According to the characteristics list, addressing server 610 determines that a modified copy of the requested item is located for example, in repository 6021. Addressing server 610 transmits a message to download-infringing user 202 to establish connection with repository 602₁ (e.g., via a link 608) and another message to repository 602₁, to respond to download-infringing user 202. Furthermore, addressing server 610 instructs repository 602₁ to upload the modified version of the requested item to download-infringing user 202. Download-infringing user 202 downloads the modified version of the requested item from repository 602₁, but download-infringing user 202 perceives that it is downloading the modified item from pseudo-sharing user 604. In this manner, pseudo-sharing users 604 and 606 operate as “agents” on behalf of repositories 602₁, 602₂ and 602_{T}, while consuming substantially small computer resources, such as bandwidth and memory.

It will be appreciated by persons skilled in the art that the present invention is not limited to what has been particularly shown and described herein above. Rather the scope of the present invention is defined only by the claims, which follow.

1. Searching server for identifying at least one infringing item in a network, the searching server comprising:
a sniffing user coupled to said network; and
a characteristics database coupled to said sniffing user, said characteristics database including at least one Intellectual Property (IP) item characteristic of at least one IP item;
wherein said sniffing user detects said at least one infringing item in a directory coupled to said network, said sniffing user retrieves at least one infringing item characteristic of said at least one infringing item from said network, and
wherein said system identifies said at least one infringing item, by comparing said at least one infringing item characteristic of said at least one infringing item, with said at least one IP item characteristic.

2. The searching server according to claim 1, wherein said searching server further comprises a signature database coupled to said sniffing user, said signature database including an IP item signature of each of said at least one IP item, and
wherein, said sniffing user downloads at least a portion of said at least one infringing item from said network, and
wherein said sniffing user identifies said at least one infringing item, by producing an infringing item signature for said at least one infringing item, and comparing said infringing item signature with said IP item signature.

3. The searching server according to claim 1, wherein said searching server further comprises a content database coupled to said sniffing user, said content database including the content of said at least one IP item.

4. The searching server according to claim 3, wherein said searching server downloads an infringing item content of said at least one infringing item form said network, and compares said infringing item content with an IP item content of said at least one IP item.

5. The searching server according to claim 2, wherein said searching server further comprises a content database coupled to said sniffing user and to said signature database, said content database including the content of said at least one IP item.

6. The searching server according to claim 5, wherein said searching server downloads an infringing item content of said at least one infringing item form said network, and compares said infringing item content with an IP item content of said at least one IP item.

7. The searching server according to claim 2, wherein said searching server is the owner of said at least one IP item.

8. The searching server according to claim 2, wherein said searching server is authorized to perform an action on behalf of the owner of said at least one IP item.

9. The searching server according to claim 8, wherein said action is selected from the list consisting of:
modifying said at least one IP item;
uploading said at least one modified IP item to a user; and
enabling the availability of said at least one modified IP item on said network.

10. The searching server according to claim 2, wherein said sniffing user detects said at least one infringing item in said directory and downloads at least a portion of said at least one infringing item from at least one share-infringing user coupled to said network.

11. The searching server according to claim 3, wherein said sniffing user detects said at least one infringing item in said directory and downloads at least a portion of said at least one infringing item from at least one share-infringing user coupled to said network.

12. The searching server according to claim 1, wherein the type of said directory is selected from the list consisting of:
centralized;
distributed; and
search engine.

13. The searching server according to claim 1, wherein the type of the connection between said directory and said network is selected from the list consisting of:
wireless link; and
wired.

14. The searching server according to claim 1, wherein the type of the connection between said sniffing user and said network is selected from the list consisting of:
wireless link; and
wired.

15. The searching server according to claim 10, wherein the type of the connection between said at least one share-infringing user and said network is selected from the list consisting of:
wireless link; and
wired.

16. The searching server according to claim 1, wherein the type of said network is selected from the list consisting of:
publicly accessed network; and
network application.

17. The searching server according to claim 10, wherein the type of said at least one share-infringing user is selected from the list consisting of:
workstation;
desktop;
laptop;
mobile unit; and
network user application.

18. The searching server according to claim 3, wherein the type of said content is selected from the list consisting of:
audio;
video;
software;
computer game
data; and
e-book.

19. The searching server according to claim 5, wherein the type of said content is selected from the list consisting of:
audio;
video;
software;
computer game;
data; and
e-book.

20. The searching server according to claim 1, wherein a translator is coupled to said network, said translator produces a translated name for said at least one infringing item and for said at least one IP item, according to said at least one infringing item characteristic and to said at least one IP item characteristic, respectively, for identifying said translated name by at least one user associated with said translator.

21. The searching server according to claim 1, wherein said production server is further coupled to a translator, said translator producing a translated name for said at least one infringing item and for said at least one IP item, according to said at least one infringing item characteristic and to said at least one IP item characteristic, respectively, for identifying said translated name by at least one user associated with another translator similar to said translator.

22. The searching server according to claim 20, wherein said production server further comprises said translator.

23. The searching server according to claim 20, wherein said production server is coupled to said translator over said network.

24. The searching server according to claim 1, wherein said at least one infringing item characteristic is identical with said at least one IP item characteristic.

25. The searching server according to claim 1, wherein said at least one infringing item characteristic is similar to said at least one IP item characteristic.

26. The searching server according to claim 1, wherein said sniffing user periodically changes at least one attribute respective thereof.

27. The searching server according to claim 26, wherein said at least one attribute is selected from the list consisting of:
network interface card identification;
logical user name;
network service provider; and
network protocol address.

28. The searching server according to claim 1, wherein said at least one IP item characteristic is selected from the list consisting of:
title;
file size;
category;
date of production;
producer; and
performer.

29. The searching server according to claim 1, wherein said at least one infringing item characteristic is selected from the list consisting of:
title;
file size;
category;
date of production;
producer; and
performer.

30. The searching server according to claim 1, further comprising at least one searching distributed user coupled to said network, said at least one searching distributed user comprising a searching characteristics database, said searching characteristics database including said at least one IP item characteristic,
wherein said at least one searching distributed user detects said at least one infringing item in said directory, said at least one searching distributed user retrieves said at least one infringing item characteristic from said network, and
wherein said at least one searching distributed user identifies said at least one infringing item, by comparing said at least one infringing item characteristic, with said at least one IP item characteristic.

31. The searching server according to claim 30, wherein said at least one searching distributed user further comprises a searching signature database, said searching signature database including an IP item signature of each of said at least one IP item, and
wherein, said at least one searching distributed user identifies said at least one infringing item, by producing an infringing item signature for said at least one infringing item, and comparing said infringing item signature with said IP item signature.

32. The searching server according to claim 30, wherein said at least one searching distributed user detects said at least one infringing item in said directory and downloads at least a portion of said at least one infringing item from at least one share-infringing user, said at least one share-infringing user is coupled to said network, said at least one searching distributed user compares the content of said at least one infringing item with the content of said at least one IP item.

33. The searching server according to claim 30, wherein the type of the connection between said at least one searching distributed user and said network is selected from the list consisting of:
wireless link; and
wired.

34. The searching server according to claim 30, wherein the type of said at least one searching distributed user is selected from the list consisting of:
workstation;
desktop;
laptop;
mobile unit; and
network user application.

35. The searching server according to claim 30, wherein said at least one searching distributed user downloads said searching characteristics database from said searching server.

36. The searching server according to claim 30, wherein said at least one searching distributed user uploads said at least one infringing item characteristic to said searching server.

37. The searching server according to claim 36, wherein said searching server uploads a selected one of said at least one IP item, and a license to use said selected at least one IP item, to said at least one searching distributed user.

38. The searching server according to claim 30, wherein said at least one searching distributed user periodically changes at least one attribute respective thereof.

39. The searching server according to claim 38, wherein said at least one attribute is selected from the list consisting of:
network interface card identification;
logical user name;
network service provider; and
network protocol address.

40. System for producing intellectual property (IP) item modified copies, the system comprising:
a network interface coupled to a network; and
a processor coupled to said network interface;
wherein said processor produces at least one modified copy from at least one item, said at least one modified copy is to be made available to said network via said network interface.

41. The system according to claim 40, wherein the type of said at least one item is selected from the list consisting of:
Intellectual Property (IP) item; and
Infringing item.

42. The system according to claim 40, wherein the type of content of said at least one item, is selected from the list consisting of:
audio;
video;
software;
computer game;
data; and
e-book.

43. The system according to claim 40, wherein said processor further comprises a translator, said translator produces a translated name for said at least one item, according to at least one item characteristic of said at least one item, respectively.

44. The system according to claim 40, wherein said processor makes said modified copy available to said network by placing a respective modified copy pointer in a directory, said directory being coupled to said network.

45. The system according to claim 44, wherein the type of said directory is selected from the list consisting of:
centralized;
distributed; and
search engine.

46. The system according to claim 40, wherein the type of the connection between said network interface and said network is selected from the list consisting of:
wireless link; and
wired.

47. The system according to claim 40, wherein the type of said network is selected from the list consisting of:
publicly accessed network; and
network application.

48. The system according to claim 40, wherein at least one modified copy characteristic of said at least one modified copy, is identical with at least one item characteristic of said at least one item.

49. The system according to claim 48, wherein said at least one modified copy characteristic is selected from the list consisting of:
title;
file size;
category;
date of production;
producer; and
performer.

50. The system according to claim 40, wherein at least one modified copy characteristic of said at least one modified copy, is similar to at least one item characteristic of said at least one item.

51. The system according to claim 50, wherein said at least one modified copy characteristic is selected from the list consisting of:
title;
file size;
category;
date of production;
producer; and
performer.

52. The system according to claim 40, wherein said at least one modified copy comprises at least two out-of-sequence segments of said at least one item separated by at least one supplementary material.

53. The system according to claim 40, wherein said at least one modified copy comprises at least two out-of-sequence segments of said at least one item followed by at least one supplementary material.

54. The system according to claim 40, wherein a first portion of said at least one modified copy comprises at least a portion of the beginning segment of said at least one item, and a second portion of said at least one modified copy comprises a recurring supplementary material.

55. The system according to claim 40, wherein the size of said at least one modified copy is substantially equal to the size of said at least one item.

56. The system according to claim 40, wherein said processor produces said at least one modified copy, when said at least one item is available to said network.

57. The system according to claim 40, wherein said processor produces said at least one modified copy, when said at least one item is not available to said network.

58. The system according to claim 57, wherein said processor produces said at least one modified copy according to predicted production parameters.

59. The system according to claim 40, wherein said processor produces a plurality of modified copy sets, each of said modified copy sets comprising said at least one modified copy, wherein at least one modified copy characteristic of said at least one modified copy in one of said modified copy sets, is different than said at least one modified copy characteristic in another one of said modified copy sets.

60. The system according to claim 40, wherein said network interface periodically changes at least one attribute respective thereof.

61. The system according to claim 60, wherein said at least one attribute is selected from the list consisting of:
network interface card identification;
logical user name;
network service provider; and
network protocol address.

62. The system according to claim 40, wherein said network interface uploads said at least one modified copy to at least one share-infringing user, at a high quality of service, during the uploading of the beginning portion of said at least one modified copy, and at a low quality of service during the uploading of the remainder of said at least one modified copy.

63. The system according to claim 40, wherein said network interface uploads said at least one modified copy to at least one share-infringing user, and wherein said network interface alternates the quality of service during said uploading between a high value and a low value.

64. The system according to claim 40, wherein said network interface has at least one identity.

65. The system according to claim 64, wherein said at least one identity is selected from the list consisting of:
media access control address;
network protocol address;
user name; and
uniform resource locator.

66. The system according to claim 40, wherein said processor attaches a digital signature of a share-infringing user to said at least one modified copy, by employing a public key of said share-infringing user.

67. System for decreasing the probability of identifying at least one item in a network, the system comprising:
a searching server; and
a production server;
said searching server further comprising:
a sniffing user coupled to said network; and
a characteristics database coupled to said sniffing user,
said production server further comprising:
a network interface coupled to said network; and
a processor coupled to said network interface,
wherein said sniffing user detects at least one infringing item in a directory coupled to said network, said sniffing user downloads at least a portion of said at least one infringing item from said network,
wherein said searching server identifies said at least one infringing item, by comparing at least one infringing item characteristic of said at least one infringing item, with at least one item characteristic of said at least one item, and
wherein said processor produces at least one modified copy of said at least one item, and said network interface makes available said at least one modified copy to said network.

68. The system according to claim 67, wherein the type of said at least one item is selected from the list consisting of:
Intellectual Property (IP) item; and
Infringing item.

69. The system according to claim 67, wherein the type of content of said at least one item, is selected from the list consisting of:
audio;
video;
software;
computer game;
data; and
e-book.

70. The system according to claim 67, wherein the type of said directory is selected from the list consisting of:
centralized;
distributed; and
search engine.

71. The system according to claim 67, wherein said sniffing user detects said at least one infringing item in said directory and downloads at least a portion of said at least one infringing item from at least one share-infringing user coupled to said network.

72. The system according to claim 67, wherein the type of the connection between said directory and said network is selected from the list consisting of:
wireless link; and
wired.

73. The system according to claim 67, wherein the type of the connection between said network interface and said network is selected from the list consisting of:
wireless link; and
wired.

74. The system according to claim 71, wherein the type of the connection between said at least one share-infringing user and said network is selected from the list consisting of:
wireless link; and
wired.

75. The system according to claim 67, wherein the type of said network is selected from the list consisting of:
publicly accessed network; and
network application.

76. The system according to claim 71, wherein the type of said at least one share-infringing user is selected from the list consisting of:
workstation;
desktop;
laptop;
mobile unit; and
network user application.

77. The system according to claim 67, wherein at least one modified copy characteristic of said at least one modified copy, is identical with said at least one item characteristic.

78. The system according to claim 77, wherein said at least one modified copy characteristic is selected from the list consisting of:
title;
file size;
category;
date of production;
producer; and
performer.

79. The system according to claim 67, wherein at least one modified copy characteristic of said at least one modified item, is similar to said at least one item characteristic.

80. The system according to claim 79, wherein said at least one modified copy characteristic is selected from the list consisting of:
title;
file size;
category;
date of production;
producer; and
performer.

81. The system according to claim 67, wherein said at least one modified copy comprises at least two out-of-sequence segments of said at least one item separated by at least one supplementary material.

82. The system according to claim 67, wherein said at least one modified copy comprises at least two out-of-sequence segments of said at least one item followed by at least one supplementary material.

83. The system according to claim 67, wherein a first portion of said at least one modified copy comprises at least a portion of the beginning segment of said at least one item, and a second portion of said at least one modified copy comprises a recurring supplementary material.

84. The system according to claim 67, wherein the size of said at least one modified copy is substantially equal to the size of said at least one item.

85. The system according to claim 67, wherein said processor produces said at least one modified copy, when said at least one item is available to said network.

86. The system according to claim 67, wherein said processor produces said at least one modified copy, when said at least one item is not available to said network.

87. The system according to claim 86, wherein said processor produces said at least one modified copy according to predicted production parameters.

88. The system according to claim 67, wherein said processor produces a plurality of modified copy sets, each of said modified copy sets comprising said at least one modified copy,
wherein at least one modified copy characteristic of said at least one modified copy in one of said modified copy sets, is different than said at least one modified copy characteristic in another one of said modified item sets.

89. The system according to claim 67, wherein said searching server further comprises a signature database coupled to said sniffing user, said signature database including an item signature of each of said at least one item,
wherein, said sniffing user identifies said at least one infringing item, by producing an infringing item signature for said at least one infringing item, and comparing said infringing item signature with said item signature.

90. The system according to claim 67, wherein said searching server is the owner of said at least one item.

91. The system according to claim 67, wherein said searching server is authorized to perform an action on behalf of the owner of said at least one item.

92. The system according to claim 91, wherein said action is selected from the list consisting of:
modifying said at least one item;
uploading said at least one modified item to a user; and
enabling the availability of said at least one modified item on said network.

93. The system according to claim 67, further comprising a content database coupled to said sniffing user, said content database including an item content of said at least one item.

94. The system according to claim 93, wherein said searching server downloads an infringing item content of said at least one infringing item form said network, and compares said infringing item content with said item content.

95. The system according to claim 89, further comprising a content database coupled to said sniffing user and to said signature database, said content database including an item content of said at least one item.

96. The system according to claim 67, wherein a translator is coupled to said network, said translator produces a translated name for said at least one infringing item and for said at least one item, according to said at least one infringing item characteristic and to said at least one item characteristic, respectively, for identifying said translated name by at least one user associated with another translator similar to said translator.

97. The system according to claim 67, wherein said production server is further coupled to a translator, said translator producing a translated name for said at least one infringing item and for said at least one IP item, according to said at least one infringing item characteristic and to said at least one IP item characteristic, respectively, for identifying said translated name by at least one user associated with another translator similar to said translator.

98. The system according to claim 96, wherein said production server further comprises said translator.

99. The system according to claim 96, wherein said production server is coupled to said translator over said network.

100. The system according to claim 67, wherein said sniffing user and said network interface periodically change at least one attribute respective thereof.

101. The system according to claim 100, wherein said at least one attribute is selected from the list consisting of:
network interface card identification;
logical user name;
network service provider; and
network protocol address.

102. The system according to claim 71, wherein said network interface uploads said at least one modified copy to said at least one share-infringing user, at a high quality of service, during the uploading of the beginning portion of said at least one modified copy, and at a low quality of service during the uploading of the remainder of said at least one modified copy.

103. The system according to claim 71, wherein said network interface uploads said at least one modified copy to said at least one share-infringing user, and wherein said network interface alternates the quality of service during said uploading between a high value and a low value.

104. The system according to claim 67, wherein said network interface has at least one identity.

105. The system according to claim 104, wherein said at least one identity is selected from the list consisting of:
media access control address;
network protocol address;
user name; and
uniform resource locator.

106. Modified item, comprising:
at least one modified item characteristic; and
modified item content,
wherein said modified item is produced according to at least one item characteristic of an item, item content of said item and at least one supplementary material.

107. The modified item according to claim 106, wherein said at least one modified item characteristic is selected from the list consisting of:
title;
file size;
category;
date of production;
producer; and
performer.

108. The modified item according to claim 106, wherein the type of said item is selected from the list consisting of:
Intellectual Property (IP) item; and
Infringing item.

109. The modified item according to claim 106, wherein the type of content of said item is selected from the list consisting of:
audio;
video;
software;
computer game;
data; and
e-book.

110. The modified item according to claim 106, wherein said at least one modified item characteristic is identical with said at least one item characteristic.

111. The modified item according to claim 106, wherein said at least one modified item characteristic is similar to said at least one item characteristic.

112. The modified item according to claim 106, wherein said modified item content comprises at least two out-of-sequence segments of said item content separated by said at least one supplementary material.

113. The modified item according to claim 106, wherein said modified item content comprises at least two out-of-sequence segments of said item content followed by said at least one supplementary material.

114. The modified item according to claim 106, wherein a first portion of said modified item content comprises at least a portion of the beginning segment of said item content, and a second portion of said modified item content comprises said at least one supplementary material, continuously recurring.

115. The modified item according to claim 106, wherein the size of said modified item is substantially equal to the size of said item.

116. The modified item according to claim 106, wherein said modified item is produced according to predicted production parameters.

117. The modified item according to claim 106, wherein said at least one modified item characteristic of each of a plurality of modified items in a modified item set, is different than said at least one modified item characteristic of each of said modified items, in another modified item set.

118. The modified item according to claim 106, wherein a translator produces a translated name for said modified item and for said item, according to said at least one modified item characteristic and to said at least one item characteristic, respectively.

119. System for sharing items in a network, the system comprising:
at least one storage unit for storing modified copies of a plurality of items; and
at least one network interface coupled to at least a selected one of said at least one storage unit and to said network, each of said at least one network interface being associated with at least selected ones of said modified copies,
wherein said at least one network interface shares said selected modified copies associated therewith, over said network.

120. The system according to claim 1 19, wherein said at least one network interface and said at least one storage unit are integrated in an item sharing server.

121. The system according to claim 119, wherein the type of said items is selected from the list consisting of:
Intellectual Property (IP) item; and
Infringing item.

122. The system according to claim 119, wherein the type of content of said items is selected from the list consisting of:
audio;
video;
software;
computer game;
data; and
e-book.

123. The system according to claim 119, wherein the type of the connection between said at least one network interface and said network is selected from the list consisting of:
wireless link; and
wired.

124. The system according to claim 119, wherein said at least one network interface reports a transmission bit rate to a bandwidth request received over said network, and uploads a selected one of said modified copies to a download-infringing user, at a bit rate different than said reported transmission bit rate.

125. The system according to claim 120, wherein the type of the connection between said item sharing server and said network is selected from the list consisting of:
wireless link; and
wired.

126. The system according to claim 119, wherein the type of said network is selected from the list consisting of:
publicly accessed network; and
network application.

127. The system according to claim 119, wherein said network perceives said at least one network interface to be a device selected from the list consisting of:
desktop;
laptop;
workstation;
mobile unit; and
network user application.

128. The system according to claim 119, wherein at least a selected characteristic of a selected one of said modified copies is identical with a respective characteristic of a respective one of said items.

129. The system according to claim 128, wherein said selected characteristic of said selected modified copy is selected from the list consisting of:
title;
file size;
category;
date of production;
producer; and
performer.

130. The system according to claim 119, wherein at least a selected characteristic of a selected one of said modified copies is similar to a respective characteristic of a respective one of said items.

131. The system according to claim 130, wherein said selected characteristic of said selected modified copy is selected from the list consisting of:
title;
file size;
category;
date of production;
producer; and
performer.

132. The system according to claim 119, wherein each of said modified copies, comprises at least two out-of-sequence segments of a respective one of said items separated by at least one supplementary material.

133. The system according to claim 119, wherein each of said modified copies, comprises at least two out-of-sequence segments of a respective one of said items followed by at least one supplementary material.

134. The system according to claim 119, wherein a first portion of each of said modified copies comprises at least a portion of the beginning segment of a respective one of said items, and wherein a second portion of each of said modified copies comprises a recurring supplementary material.

135. The system according to claim 119, wherein the size of each of said modified copies is substantially equal to the size of a respective one of said items.

136. The system according to claim 119, wherein each of said modified copies is produced according to predicted production parameters, when a respective one of said items is not available to said network.

137. The system according to claim 119, wherein at least one modified copy characteristic of each of said modified copies in a modified copy set, is different than said at least one modified copy characteristic of each of said modified copies, in another modified copy set.

138. The system according to claim 119, wherein a translator is coupled to said network, said translator produces a translated name for each of said modified copies, according to at least one modified copy characteristic of a respective one of said modified copies, for identifying said translated name by at least one user associated with another translator similar to said translator.

139. The system according to claim 138, wherein said translator is integrated with an item sharing server.

140. The system according to claim 119, wherein said at least one network interface is associated with a modified copy set, and wherein each of said modified copy sets includes a different selection of said modified copies.

141. The system according to claim 119, wherein said at least one network interface periodically changes at least one attribute respective thereof.

142. The system according to claim 141, wherein said at least one attribute is selected from the list consisting of:
network interface card identification;
logical user name;
network service provider; and
network protocol address.

143. The system according to claim 119, wherein said at least one network interface uploads said modified copy, and at least one of said modified copies to at least one download-infringing user, at a high quality of service, during the uploading of the beginning portion of at least one of said modified copies, and at a low quality of service during the uploading of the remainder of at least one of said modified copies.

144. The system according to claim 119, wherein said at least one network interface uploads at least one of said modified copies, to at least one download-infringing user, and wherein each of said at least one network interface alternates the quality of service during said uploading between a high value and a low value.

145. The system according to claim 119, wherein said at least one network interface has at least one identity.

146. The system according to claim 145, wherein said at least one identity is selected from the list consisting of:
media access control address;
network protocol address;
user name; and
uniform resource locator.

147. The system according to claim 120, wherein said item sharing server further comprises a plurality of different fixed delay units coupled to said network, and wherein each of said different fixed delay units is coupled to a selected one of said at least one network interface.

148. The system according to claim 147, wherein each of said different fixed delay units applies a time delay, to a response of said selected network interface, to a network request.

149. The system according to claim 120, wherein said item sharing server further comprises a random delay unit coupled to said network and to said at least one network interface.

150. The system according to claim 149, wherein said random delay unit delays a response of a selected one of said at least one network interface, to a network request, by a random delay period.

151. The system according to claim 119, wherein said at least one network interface is distributed within said network and said at least one storage unit is integrated in an item sharing server.

152. The system according to claim 151, wherein said item sharing server uploads at least a portion of at least selected ones of said modified copies to said at least one network interface.

153. The system according to claim 152, wherein said item sharing server performs said uploading, when the traffic in said network is low.

154. The system according to claim 151, wherein said item sharing server uploads the beginning portion of at least selected ones of said modified copies, and at least one supplementary material, to said at least one network interface.

155. The system according to claim 154, wherein said item sharing server performs said uploading, when the traffic in said network is low.

156. The system according to claim 154, wherein said at least one network interface produces a combined copy of at least selected ones of said modified copies, by combining said beginning portion with recurring ones of said at least one supplementary material, said recurring supplementary material following said beginning portion,
wherein the size of said combined copy is substantially equal to the size of a respective one of said items, and

157. The system according to claim 151, wherein said item sharing server uploads at least two segments of at least one of at least selected ones of said modified copies to said at least one network interface.

158. The system according to claim 157, wherein said at least one network interface produces a combined copy of at least selected ones of said modified copies, by combining recurring ones of said at least two segments out-of-sequence,
wherein the size of said combined copy is substantially equal to the size of a respective one of said items, and wherein said at least one download-infringing user downloads said combined copy.

159. The system according to claim 158, wherein said at least one network interface uploads said combined copy to said at least one download-infringing user.

160. The system according to claim 151, wherein at least selected ones of said modified copies is malfunctioning.

161. The system according to claim 119, wherein said at least one network interface determines an e-mail address of at least one download-infringing user, according to a user name of said at least one download-infringing user, when said at least one network interface uploads a selected one of said modified copies to said at least one download-infringing user, and said at least one network interface sends an e-mail message to said at least one download-infringing user.

162. The system according to claim 161, wherein the subject of said e-mail message is selected from the list consisting of:
notification that said at least one download-infringing user is infringing IP protected rights;
the means by which said at least one download-infringing user can obtain an IP protected copy of said respective item;
advertisement; and
commercial promotion.

163. The system according to claim 151, wherein at least additional ones of said at least one network interface are coupled to said at least one network interface via Internet Protocol multicasting.

164. The system according to claim 156, wherein said item sharing server deletes said combined copy from said at least one network interface, when said combined copy is not downloaded frequently.

165. The system according to claim 119, further comprising an addressing server, wherein said at least one network interface and said at least one storage unit are distributed within said network, and
wherein said addressing server includes a list of at least one modified copy characteristic of each of said modified copies, each entry in said list points to a selected one of said storage units.

166. The system according to claim 165, wherein said at least one network interface performs a peer brokering operation between at least one download-infringing user and said selected storage unit, thereby directing said at least one download-infringing user to download from said selected storage unit.

167. The system according to claim 165, wherein the type of the connection between said addressing server and said network is selected from the list consisting of:
wireless link; and
wired.

168. Method for reducing the probability for identifying an item in a network, the method comprising the steps of:
associating a plurality of network interfaces with a modified copy of said item; and
enabling availability of said modified copy through said network interfaces.

169. The method according to claim 168, further comprising a preliminary step of updating at least one selected network node respective of said modified copy.

170. The method according to claim 169, wherein said at least one selected network node is a directory.

171. The method according to claim 169, further comprising a preliminary step of producing said modified item, respective of an infringing copy of said item.

172. The method according to claim 171, further comprising a preliminary step of identifying said infringing copy in said network.

173. The method according to claim 168, wherein the type of said item is selected from the list consisting of:
Intellectual Property (IP) item; and
Infringing item.

174. The method according to claim 168, wherein the type of said network is selected from the list consisting of:
publicly accessed network; and
network application.

175. The method according to claim 168, further comprising a step of uploading said modified copy to a download-infringing user from a selected one of said network interfaces.

176. The method according to claim 168, further comprising a step of detecting a selected one of said modified copies in said network by a download-infringing user, according to a translated name of said selected modified copy.

177. The method according to claim 168, further comprising a step of changing at least one attribute of each of said network interfaces.

178. The method according to claim 177, wherein said at lease one attribute is selected from the list consisting of:
network interface card identification;
logical user name;
network service provider; and
network protocol address.

179. The method according to claim 168, further comprising a step of uploading selected ones of said modified copies to a download-infringing user by a selected one of said network interfaces, at a high quality of service, during the uploading of the beginning portion of said selected modified copy, and at a low quality of service during the uploading of the remainder of said selected modified copy.

180. The method according to claim 168, further comprising a step of uploading selected ones of said modified copies to a download-infringing user by a selected one of said network interfaces, wherein the quality of service in said step of uploading alternates between a high value and a low value.

181. Method for detecting an infringing copy of an Intellectual Property (IP) item in a network, the method comprising the steps of:
inspecting a search result for identifying said infringing copy; and
comparing at least one infringing copy characteristic of said infringing copy, with at least one IP item characteristic of said IP item, when said infringing copy is identified.

182. The method according to claim 181, wherein said step of inspecting further comprises a procedure of retrieving at least one search characteristic from said search result.

183. The method according to claim 181, further comprising a step of downloading at least a portion of said identified infringing copy.

184. The method according to claim 183, further comprising a step of comparing the content of said infringing copy, with the content of said IP item, when said at least one infringing copy characteristic and said at least one IP item characteristic match.

185. The method according to claim 181, further comprising a step of recording an address of said identified infringing copy in said network.

186. The method according to claim 181, further comprising a preliminary step of initiating a search for said infringing copy, at least one infringing copy characteristic of said infringing copy being at least similar to at least one IP item characteristic of said IP item, and producing said search result.

187. The method according to claim 186, further comprising a preliminary step of defining said at least one IP item characteristic.

188. The method according to claim 181, wherein the type of said network is selected from the list consisting of:
publicly accessed network; and
network application.

189. The method according to claim 181, wherein the type of the content of said IP item is selected from the list consisting of:
audio;
video;
software;
computer game;
data; and
e-book.

190. The method according to claim 186, wherein said step of initiating is performed according to a translated name of said infringing copy.
